(19) United States
(12) Patent Application Publication
(10) Pub. No.: US 2013/0271675 A1
(43) Pub. Date: Oct. 17, 2013

(54) TOUCH PANEL, DISPLAY APPARATUS INCLUDING THE SAME, AND METHOD FOR MANUFACTURING TOUCH PANEL

(71) Applicant: Katsunori Misaki, Yonago-shi (JP)

(72) Inventor: Katsunori Misaki, Yonago-shi (JP)

(73) Assignee: SHARP KABUSHIKI KAISHA, Osaka-shi, Osaka (JP)

(21) Appl. No.: 13/995,532

(22) PCT Filed: Dec. 21, 2011
(86) PCT No.: PCT/JP2011/007165

§ 371 Date: Jun. 19, 2013

(30) Foreign Application Priority Data
Dec. 28, 2010 (JP) 2010-293127

(51) Int. Cl. G06F 3/041; G02F 1/1333

(52) U.S. Cl. CPC G06F 3/041; G02F 1/13338
USPC 349/12; 345/173; 430/312

(57) ABSTRACT

A conductive connection part (33) electrically connecting a conductive pattern (17) in a touch region (T1) to a lead line (30) includes a first connection layer (34A) formed below an interlayer insulating film (23) and connected so as to overlap with a base end part (30s) of the lead line (30), and a second connection layer (34B) connected to the first connection layer (34A) and crossing over a peripheral line (32) with the interlayer insulating film (23) being interposed between the second connection layer (34B) and the peripheral line (32).

### TECHNICAL FIELD

The present disclosure relates to a touch panel, a display apparatus including the touch panel, and a method for manufacturing the touch panel. In particular, the present disclosure relates to countermeasures against detection failure of a touch position.

### BACKGROUND ART

A touch panel is provided on a display panel such as a liquid crystal display panel or a plasma display panel, thereby forming a display apparatus. The touch panel is an input device configured to input information to a main body of the display apparatus in such a manner that a finger or a pen is used on a display screen of the display panel to perform various operations.

Touch panels are, according to operating principles thereof, classified into resistive touch panels, capacitive touch panels, infrared touch panels, ultrasonic touch panels, and electromagnetic touch panels. Of those touch panels, the capacitive touch panels have been known as being suitable for display apparatuses because optical properties of the display apparatuses are relatively less likely to be degraded. In particular, projected capacitive touch panels are capable of performing multipoint detection of a contact body such as a finger, and therefore have good operability to realize input of complex command information.

The projected capacitive touch panel includes a touch region arranged corresponding to a display region such that a touch position is detectable, and a frame region arranged corresponding to a non-display region outside the display region. In the touch region, as electrodes for touch position detection, plural lines of first electrode groups each including a plurality of first electrodes arranged in one direction are arranged parallel to each other, and plural lines of second electrode groups each including a plurality of second electrodes arranged in a direction perpendicular to the first electrode groups are arranged parallel to each other (see, e.g., Patent Document 1). The first and second electrodes are each made of a transparent conductive oxide, such as an indium tin oxide (hereinafter referred to as an “ITO”), having low conductivity so that a display screen of a display panel can be seen through the touch panel.

In each of the first electrode groups, adjacent ones of the first electrodes are connected together through a first connection part. In each of the second electrode groups, adjacent ones of the second electrodes are connected together through a second connection part. As in the first and second electrodes, the first and second connection parts are also made of a transparent conductive oxide. In each intersection of the first and second electrode groups, the first and second connection parts are provided with an interlayer insulating film being interposed therebetween, and therefore are insulated from each other. The first electrode groups and the second electrode groups are electrically connected to different lead lines extending on the frame region from the touch region toward a terminal region located outside the touch region. Each lead line is covered by the interlayer insulating film.

A conductive connection part is connected to a base end part of each lead line. Each conductive connection part is connected to the first or second electrode group. On the other hand, an external connection terminal is connected to a tip end part of each lead line. Each external connection terminal is connected to a capacitive detection circuit configured to apply alternating voltage to the first and second electrode groups and to detect electrostatic capacitance at part corresponding to each of the first and second electrodes. The first and second electrodes are covered by a protective insulating film.

In this touch panel, when the insulating film in the touch region is touched, the first and second electrodes at a touch position are grounded via electrostatic capacitance generated between each of the first and second electrodes and a contact body such as a finger and via a human body. At this time, a change in electrostatic capacitance generated between each of the first and second electrodes at the touch position and the contact body is detected by the capacitive detection circuit. As in the foregoing, the structure is employed, in which the touch position is detected based on the change in electrostatic capacitance.

In the foregoing projected capacitive touch panel, a ground line is, in the periphery of the touch region, formed so as to pass between the electrode (i.e., each of the first and second electrodes) for touch position detection and the lead line. The ground line is covered by the interlayer insulating film, and is formed of the same film as that of the lead lines in order to simplify manufacturing steps.

Each conductive connection part is provided so as to cross over the ground line with the interlayer insulating film being interposed between the conductive connection part and the ground line, and is insulated from the ground line. The conductive connection part is formed of, e.g., the same film as that of the first or second connection part, and is made of a transparent conductive oxide. The conductive connection part is connected to the base end part of the lead line through a contact hole formed in the interlayer insulating film. In order to reduce resistance as much as possible and to reduce or prevent electric corrosion upon connection with a transparent conductive layer such as the conductive connection part, a multilayer structure in which a high-melting metal layer, an aluminum layer, and a high-melting metal layer are stacked on each other in this order is preferably employed for the lead line.

### CITATION LIST

### Patent Document

PATENT DOCUMENT 1: Japanese Patent Publication No. 2010-257442

### SUMMARY OF THE INVENTION

### Technical Problem

In the foregoing projected capacitive touch panel, many first and second electrode groups are, in order to realize highly-accurate touch position detection, formed such that adjacent ones of the electrodes are close to each other, and therefore many lead lines are also formed so as to extend next to each other in the frame region. If such a touch panel is employed for a display panel having a narrow frame structure in which a frame region which is a non-display region is narrow, it is necessary that the touch panel has, in the frame region thereof, a narrow frame structure corresponding to the frame region of the display panel. Thus, it is inevitable that many lead lines are densely formed and the width of each lead line is decreased.

However, since the conductive connection part is formed on the interlayer insulating film so as to be insulated from the ground line, it is necessary that the conductive connection part is connected to the base end part of the lead line through the contact hole formed in the interlayer insulating film. When the interlayer insulating film is formed by photolithography, if the width of the lead line is small, there is a possibility that the contact hole cannot be, although depending on the smallness of the width of the lead line, formed within an area on the base end part of the lead line at normal resolution. In such a case, the contact hole is formed such that a side end surface of the lead line is within the contact hole. Even when the contact hole can be formed at such photolithography resolution that the contact hole is formed within the area on the base end part of the lead line, if the formation position of the contact hole is only slightly displaced with respect to the base end part of the lead line having a small width, the contact hole is, as in the foregoing, formed such that the side end surface of the lead line is within the contact hole.

In the case where the contact hole is formed such that the side end surface of the lead line is within the contact hole, the aluminum layer contributing to reduction in resistance of the lead line has the property of being dissolved with a developer used for photolithography, but is exposed to the developer at the side end surface of the lead line upon formation of the interlayer insulating film. Thus, the aluminum layer is dissolved. In the worst case, part of the aluminum layer in a line width direction is lost, and the base end part of the lead line is partially peeled off. In such a case, connection failure between the conductive connection part and the lead line occurs, and therefore conduction failure between the electrode for touch position detection and the capacitive detection circuit occurs. This lowers a touch position detection function.

The present disclosure has been made in view of the foregoing, and it is an objective of the present disclosure to ensure, in the structure in which a peripheral line around a touch region and conductive connection parts are insulated from each other by an interlayer insulating film, connection between the conductive connection part and a lead line to realize a good touch position detection function.

### Solution to the Problem

According to the present disclosure, in order to accomplish the foregoing objective, a conductive connection part is formed of two connection layers, and a connection structure between each of the two connection layers and a lead line is devised.

Specifically, the present disclosure is intended for a touch panel including a touch region which is a region where a touch position at which the touch panel had contact with a contact body is detected; a terminal region which is a region formed outside the touch region and formed for connection with an external circuit; a first conductive pattern formed for touch position detection and arranged in the touch region; an interlayer insulating film formed so as to cover at least part of the first conductive pattern; a second conductive pattern formed so as to cross the first conductive pattern with the interlayer insulating film being interposed between the first and second conductive patterns; a lead line extending from the touch region toward the terminal region and covered by the interlayer insulating film; a peripheral line extending around the touch region so as to pass between at least one of the first or second conductive pattern and a base end part of the lead line; and a conductive connection part which is provided so as to cross over the peripheral line with the interlayer insulating film being interposed between the conductive connection part and the peripheral line, and which is connected to at least one of the first or second conductive pattern and the base end part of the lead line to electrically connect the at least one of the first or second conductive pattern in the touch region to the lead line. The present disclosure is also intended for a display apparatus including the touch panel and a method for manufacturing the touch panel. The following solutions have been made.

That is, a first aspect of the invention is intended for the touch panel in which the conductive connection part includes a first connection layer formed below the interlayer insulating film and connected so as to overlap with the base end part of the lead line, and a second connection layer connected to the first connection layer with the second connection layer crossing over the peripheral line.

In the first aspect of the invention, since the first connection layer is formed below the interlayer insulating film and is connected so as to overlap with the base end part of the lead line, it is ensured that the conductive connection part and the lead line are connected together through the first connection layer. Moreover, since the second connection layer crossing over the peripheral line with the interlayer insulating film being interposed between the second connection layer and the peripheral line is connected to the first connection layer, the conductive connection part is insulated from the peripheral line by the second connection layer. Thus, in the configuration in which the peripheral line extending around the touch region and the conductive connection part are insulated from each other by the interlayer insulating film, it can be ensured that the conductive connection part and the lead line are connected together. Consequently, a good touch position detection function can be realized.

A second aspect of the invention is intended for the touch panel of the first aspect of the invention, in which the first connection layer is formed of a film identical to that of the first conductive pattern, and the second connection layer is formed of a film identical to that of the second conductive pattern.

In the second aspect of the invention, the first connection layer is formed of the film identical to that of the first conductive pattern, and the second connection layer is formed of the film identical to that of the second conductive pattern. That is, the existing steps of forming the first and second conductive patterns can be used to form the conductive connection part having the connection structure of the two connection layers. Thus, the step of forming the conductive connection part is not necessary in addition to the steps of forming the first and second conductive patterns. The number of manufacturing steps is not increased, and a manufacturing cost is not increased.

A third aspect of the invention is intended for the touch panel of the first or second aspect of the invention, in which the base end part of the lead line is formed so as to have a width larger than that of a middle part of the lead line between end parts thereof, and includes a plurality of thin line parts which are integrally formed such that a clearance is formed between adjacent ones of the thin line parts.

In the third aspect of the invention, the base end part of the lead line is formed so as to have a width larger than that of the middle part of the lead line between the end parts thereof. Thus, as compared to the case where the base end part of the lead line is formed so as to have a width equal to or smaller than that of the middle part of the lead line, a connection area between the base end part of the lead line and the conductive connection part can be increased, and conductivity between the lead line and the conductive connection part can be improved. Moreover, a margin for displacement of formation positions of the conductive connection part and the lead line is ensured, and therefore it can be further ensured that the conductive connection part and the lead line are connected together.

Considering reduction in thickness of the entirety of a liquid crystal display apparatus, it is preferable that the touch panel is formed directly on a surface of a substrate forming a liquid crystal display panel or a surface of a substrate forming a liquid crystal panel which is called a “switching liquid crystal panel” and which is used for a 2D/3D switchable liquid crystal display apparatus to switch between a 2D display and a 3D display.

So-called “drop filling” advantageous to a production efficiency is preferably used as a method for manufacturing the liquid crystal display panel or the switching liquid crystal panel. In drop filling, a sealing material made of ultraviolet curable resin is applied in a frame shape on a surface of one of two substrates, and a liquid crystal material is dropped onto a region surrounded by the sealing material. Then, such a substrate is bonded to the other substrate, and the sealing material is irradiated with ultraviolet light. The sealing material is cured to bond the substrates together.

However, in, e.g., the case where a touch panel is formed on one of the substrates, and then the substrate with the touch panel is bonded to the other substrate by the sealing material to manufacture the liquid crystal display panel or the switching liquid crystal panel, i.e., the case where the touch panel is formed on one of the substrates before the substrates are bonded together, if a lead line is formed so as to have a wide part, ultraviolet light irradiated from a side close to the touch panel is blocked by such a wide part, and does not reach the sealing material. Thus, an uncured part may remain in the sealing material. In such a case, adhesive force between the substrates is reduced. Moreover, a component(s) of the uncured part of the sealing material enters a liquid crystal layer, and therefore a display quality is degraded due to instability of an alignment state of liquid crystal molecules or occurrence of blurring or unevenness in a displayed image.

In this regard, according to the third aspect of the invention, the base end part of the lead line is formed so as to have a large width, but the plurality of thin line parts integrally formed such that the clearance is formed between adjacent ones of the thin line parts form the base end part of the lead line. Thus, the sealing material can be irradiated with ultraviolet light through the clearance between adjacent ones of the thin line parts, and therefore the uncured part of the sealing material can be reduced.

A fourth aspect of the invention is intended for the touch panel of any one of the first to third aspects of the invention, in which the first connection layer protrudes from a region overlapping with the base end part of the lead line toward an outer region, the second connection layer is connected to the first connection layer so as to partially overlap with a protrusion of the first connection layer, and an entirety of the lead line is covered by the interlayer insulating film.

In the fourth aspect of the invention, the second connection layer is connected so as to overlap with the protrusion of the first connection layer protruding from the region overlapping with the base end part of the lead line toward the outer region. According to such a connection structure between the first and second connection layers, a contact hole is not necessarily formed in part of the interlayer insulating film corresponding to the lead line. Thus, the entirety of the lead line can be covered by the interlayer insulating film, and dissolving of the lead line with a developer used for forming the interlayer insulating film can be avoided. This reduces or prevents losing of part of the lead line and therefore peeling of the lead line due to the losing of part of the lead line. In such a good formation state of the lead line, it can be ensured that the conductive connection part and the lead line are connected together.

A fifth aspect of the invention is intended for the touch panel of the third aspect of the invention, in which, in the interlayer insulating film, a contact hole reaching the first connection layer is formed corresponding to part of the clearance between adjacent ones of the thin line parts, and the second connection layer is connected to the first connection layer through the contact hole.

In the fifth aspect of the invention, since the contact hole is, in the interlayer insulating film, formed corresponding to part of the clearance between adjacent ones of the thin line parts, the contact hole reaches the first connection layer through the clearance between adjacent ones of the thin line parts. The second and first connection layers are connected together through the contact hole at part corresponding to the clearance between adjacent ones of the thin line parts. In the touch panel having such a configuration, the features and advantages of the present disclosure are specifically realized.

A sixth aspect of the invention is intended for the touch panel of the fifth aspect of the invention, in which the thin line parts are combined into a frame-shaped part surrounding part of the first connection layer, the contact hole is formed so as to be surrounded by the frame-shaped part, and an entirety of the lead line is covered by the interlayer insulating film.

In the sixth aspect of the invention, since the contact hole is formed so as to be surrounded by the frame-shaped part formed of the thin line parts, the entirety of the lead line can be covered by the interlayer insulating film. Thus, dissolving of the lead line with the developer used for forming the interlayer insulating film can be avoided. This reduces or prevents losing of part of the lead line and therefore peeling of the lead line due to the losing of part of the lead line. In such a good formation state of the lead line, it can be ensured that the conductive connection part and the lead line are connected together.

A seventh aspect of the invention is intended for the touch panel of the fifth aspect of the invention, in which the contact hole is formed such that part of side end surfaces of the thin line parts is within the contact hole, and the second connection layer is connected to the first connection layer and the thin line parts through the contact hole.

In the seventh aspect of the invention, the contact hole is formed such that part of the side end surfaces of the thin line parts are within the contact hole. Thus, although part of the thin line parts is, at the side end surfaces thereof, dissolved with the developer used for forming the interlayer insulating film and is lost, the remaining part of the thin line parts other than part where the contact hole is formed is covered by the interlayer insulating film, and therefore it can be ensured that the thin line parts covered by the interlayer insulating film and the first connection layer are connected together. Consequently, even if part of the thin line parts is, at the part where the contact hole is formed, dissolved with the developer used for forming the interlayer insulating film and is lost, it can be ensured that the conductive connection part and the lead line are connected together.

An eighth aspect of the invention is intended for the touch panel of any one of the first to seventh aspects of the invention, in which the first and second connection layers are made of a transparent conductive oxide, and the lead line is formed such that a high-melting metal layer, an aluminum layer, and a high-melting metal layer are stacked on each other in this order.

In the eighth aspect of the invention, since the lead line has the multilayer structure of the high-melting metal layer which is less likely to cause electric corrosion due to a transparent conductive oxide and the aluminum layer having relatively-low resistance, excellent conductivity of the lead line can be realized in such a manner that the resistance of the lead line is reduced as much as possible, and electric corrosion due to connection between each of the first and second connection layers and the lead line can be reduced or prevented.

A ninth aspect of the invention is intended for the touch panel of any one of the first to eighth aspects of the invention, in which one of the first or second conductive pattern includes a plurality of first electrode groups each including a plurality of first electrodes arranged in one direction and arranged parallel to each other, a plurality of second electrode groups each including a plurality of second electrodes arranged in a direction crossing the first electrode groups and arranged parallel to each other, and a first connection part connecting adjacent ones of the first electrodes in each of the first electrode groups, and the other one of the first or second conductive pattern includes a second connection part connecting adjacent ones of the second electrodes in each of the second electrode groups.

According to the ninth aspect of the invention, a projected capacitive touch panel can be specifically realized. Since the first and second electrode groups are provided in the same layer in such a touch panel, the substantially same degree of change in electrostatic capacitance formed between each of the first and second electrodes at a touch position and a contact body such as a finger can occur. Thus, a difference in sensitivity to a change in electrostatic capacitance between the first and second electrodes can be reduced, and therefore a touch position can be detected with good sensitivity.

A tenth aspect of the invention is intended for a display apparatus including the touch panel of any one of the first to ninth aspects of the invention.

According to the tenth aspect of the invention, since the touch panel of the first to ninth aspects of the invention has such an excellent property that connection between the conductive connection part and the lead line is ensured to realize a good touch position detection function, a display apparatus which is capable of inputting accurate information in such a manner that a contact body such as a finger or a pen is used to perform various operations can be realized.

An eleventh aspect of the invention is intended for the display apparatus of the tenth aspect of the invention, which further includes a display panel configured to generate a display image corresponding to input image data; parallax barrier means configured to allow viewing of the display image generated by the display panel at particular different angles of view between first and second display regions of the display image; and a switching liquid crystal panel configured to switch between validation and invalidation of a function of the parallax barrier means to switch between first and second display states. The touch panel is formed directly on a surface of a substrate forming the switching liquid crystal panel.

According to the eleventh aspect of the invention, a first/second display switchable liquid crystal display apparatus including the touch panel which is capable of inputting accurate information and configured to switch between the first and second display states can be realized. Since the touch panel is formed directly on the surface of the substrate forming the switching liquid crystal panel, the entirety of the first/second display switchable liquid crystal display apparatus with the touch panel can be configured so as to have a small thickness.

A twelfth aspect of the invention is intended for a method for manufacturing the touch panel of the first aspect of the invention, which includes a first patterning step of patterning, by using a first photo mask, a transparent conductive film made of a transparent conductive oxide and formed on a base substrate, thereby forming the first conductive pattern and the first connection layer; a second patterning step of patterning, by using a second photo mask, a metal film formed so as to cover the first conductive pattern and the first connection layer, thereby forming the lead line such that the base end part is connected so as to overlap with the first connection layer; a third patterning step of patterning, by using a third photo mask, an insulating film formed so as to cover the first conductive pattern, the first connection layer, and the lead line, thereby forming the interlayer insulating film such that at least part of the first conductive pattern and the first connection layer is exposed; a fourth patterning step of patterning, by using a fourth photo mask, a transparent conductive film made of a transparent conductive oxide and formed on the interlayer insulating film, thereby forming the second conductive pattern and forming the second connection layer such that the second connection layer is connected to the first conductive pattern and the first connection layer; and a fifth patterning step of patterning, by using a fifth photo mask, an insulating film formed so as to cover the second conductive pattern and the second connection layer, thereby forming a protective insulating film.

In the twelfth aspect of the invention, the single photo mask is, in the first patterning step, used to form the first conductive pattern and the first connection layer from the identical film. In the fourth patterning step, the single photo mask is used to form the second conductive pattern and the second connection layer from the identical film. As described above, the existing steps of forming the first and second conductive patterns are used to form the first and second connection layers. Thus, since the connection structure including the two connection layers can be formed without adding a manufacturing step(s), it can be, without increasing a manufacturing cost, ensured that the conductive connection part and the lead line are connected together, and the touch panel of the first aspect of the invention can be manufactured with a good touch position detection function.

### Advantage of the Invention

According to the present disclosure, the conductive connection part electrically connecting the conductive pattern in the touch region to the lead line includes the first connection layer formed below the interlayer insulating film and connected so as to overlap with the base end part of the lead line, and a second connection layer connected to the first connection layer with the second connection layer crossing over the peripheral line. Thus, in the configuration in which the peripheral line extending around the touch region and the conductive connection part are insulated from each other by the interlayer insulating film, it can be ensured that the conductive connection part and the lead line are connected together, and therefore a good touch position detection function can be realized. As a result, conduction failure between the conductive pattern for touch position detection and the external circuit can be reduced or prevented, and a display apparatus which is capable of inputting accurate information in such a manner that a contact body such as a finger or a pen is used to perform various operations can be realized.

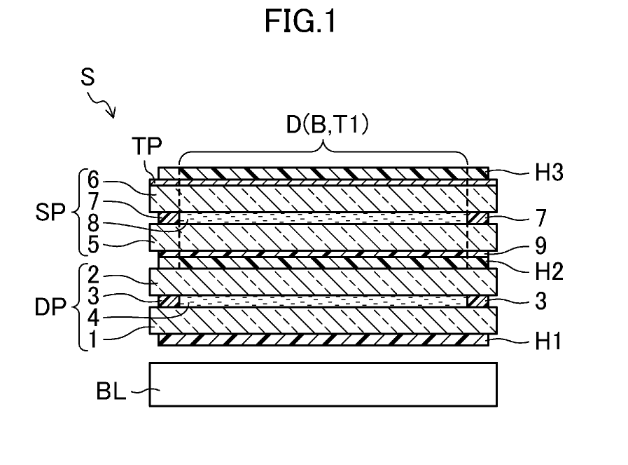

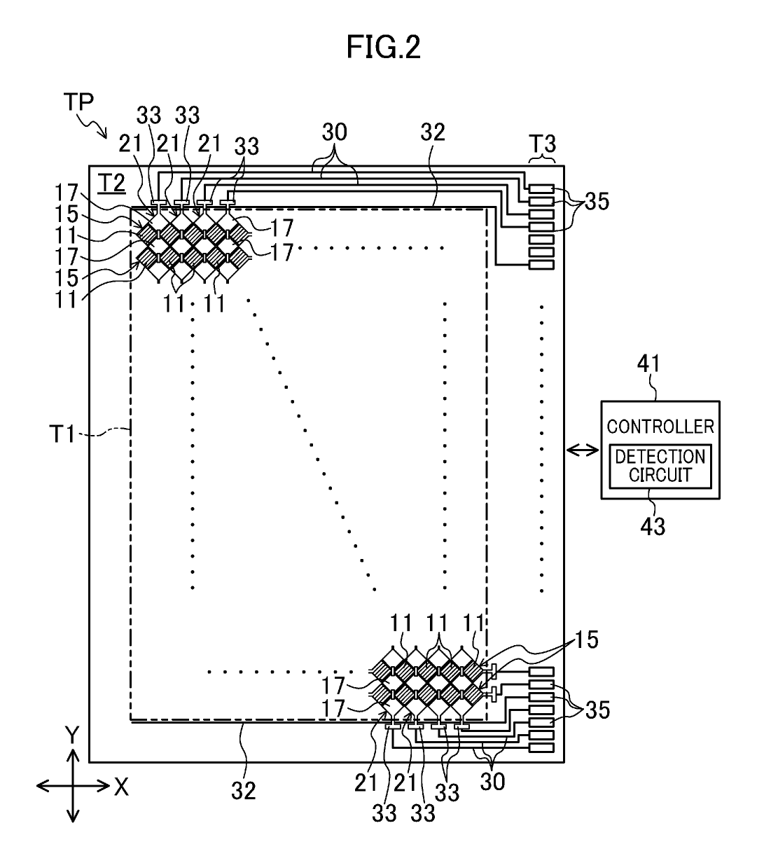

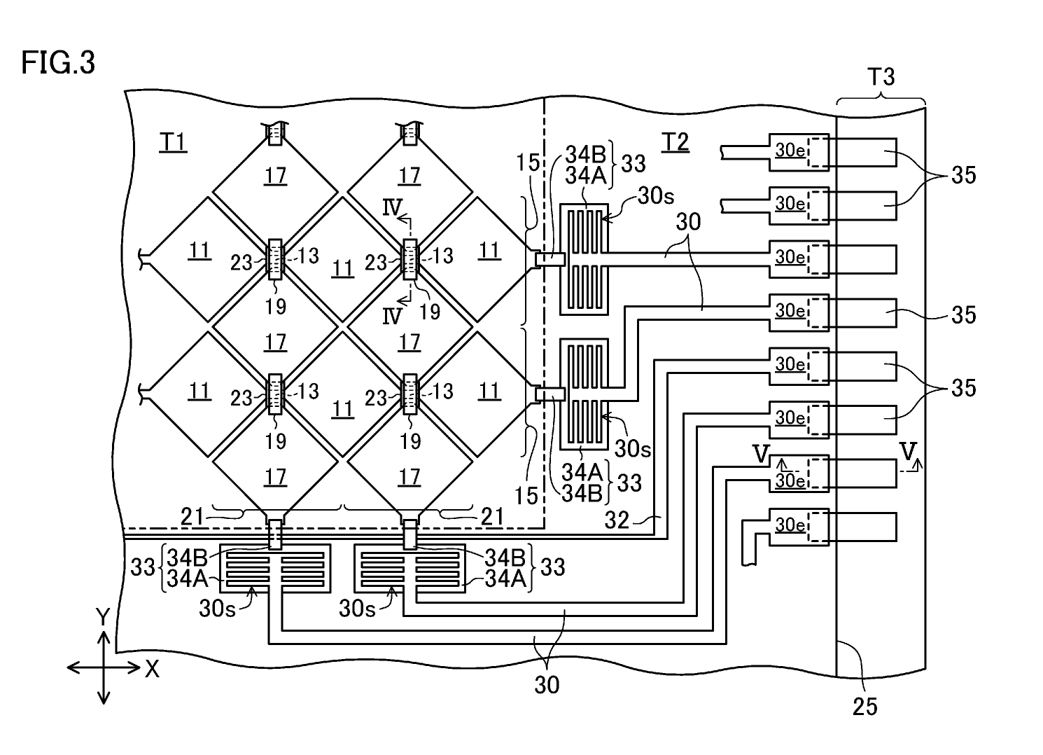

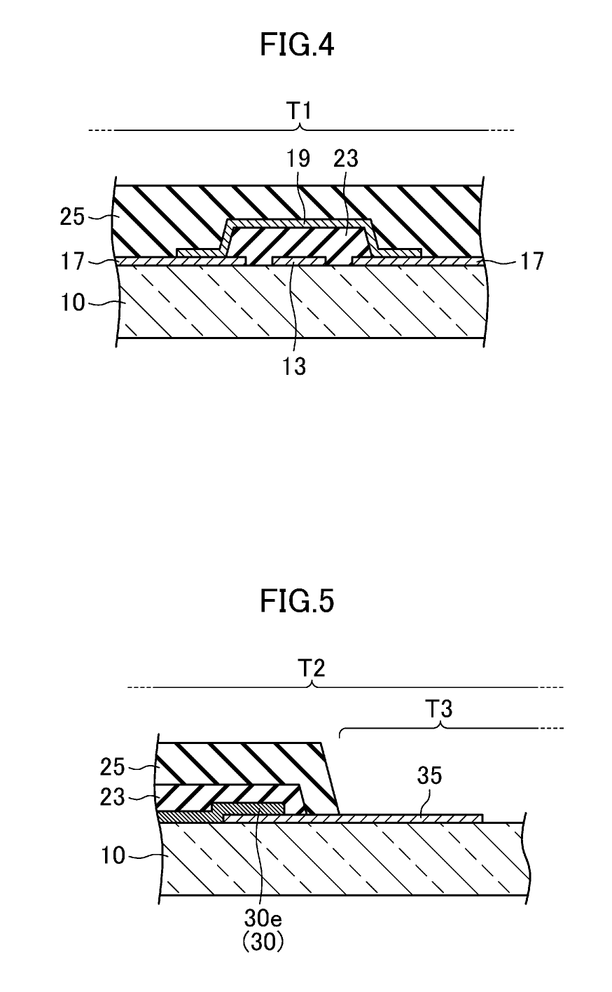

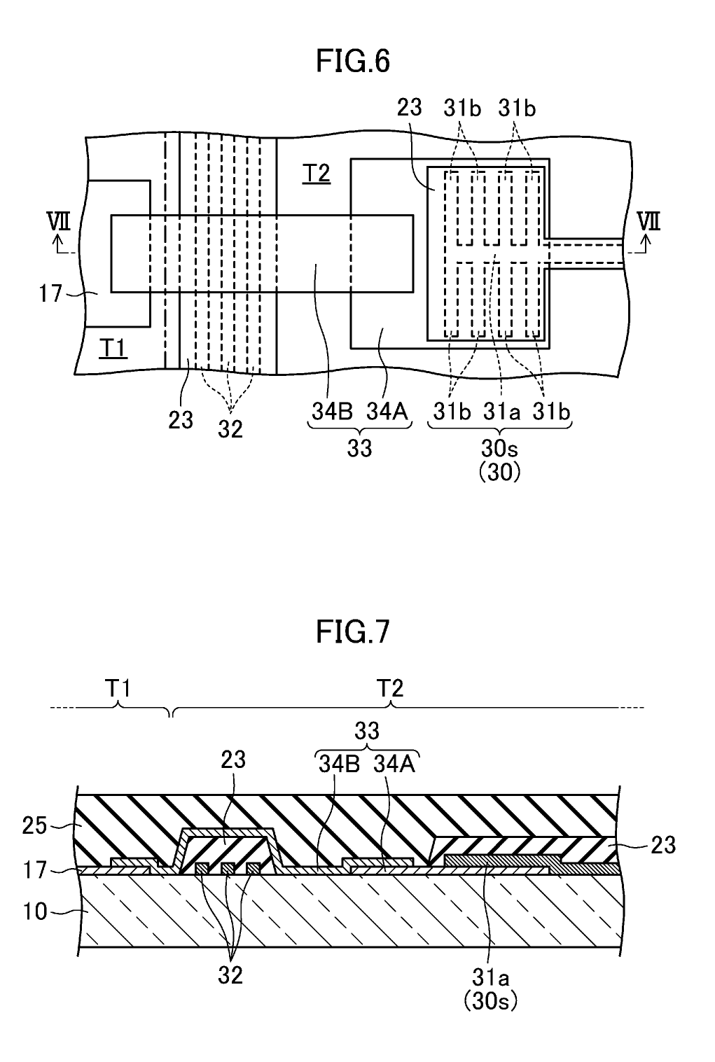

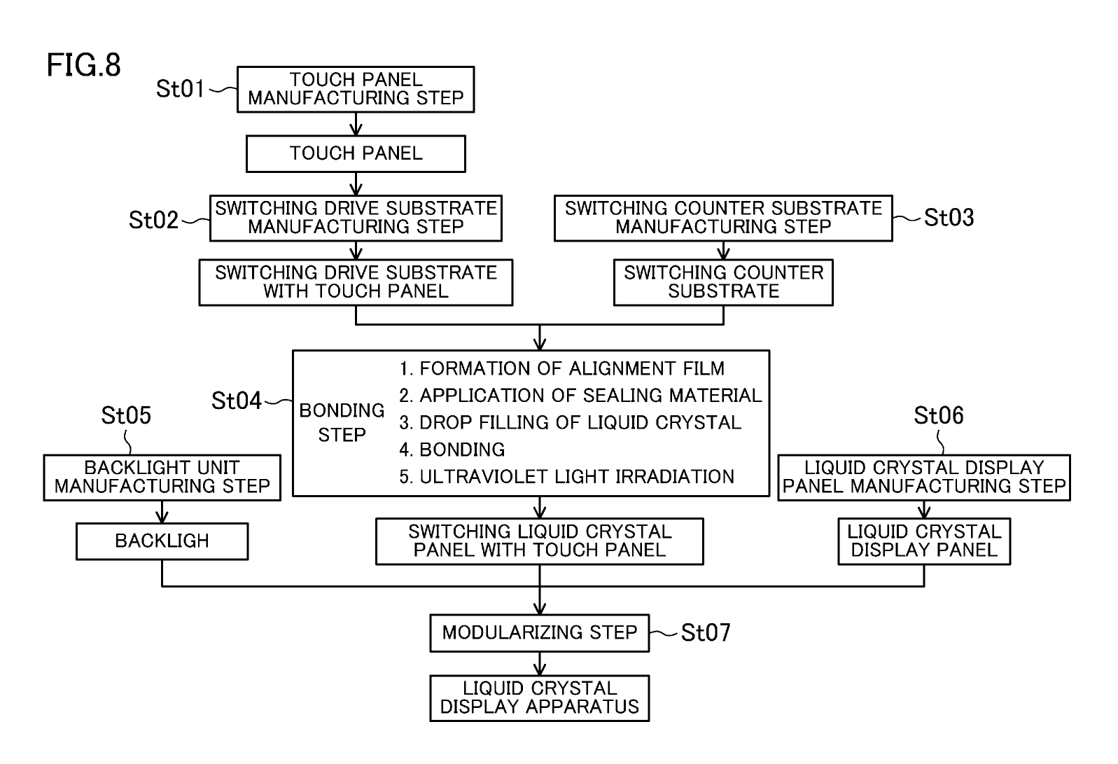

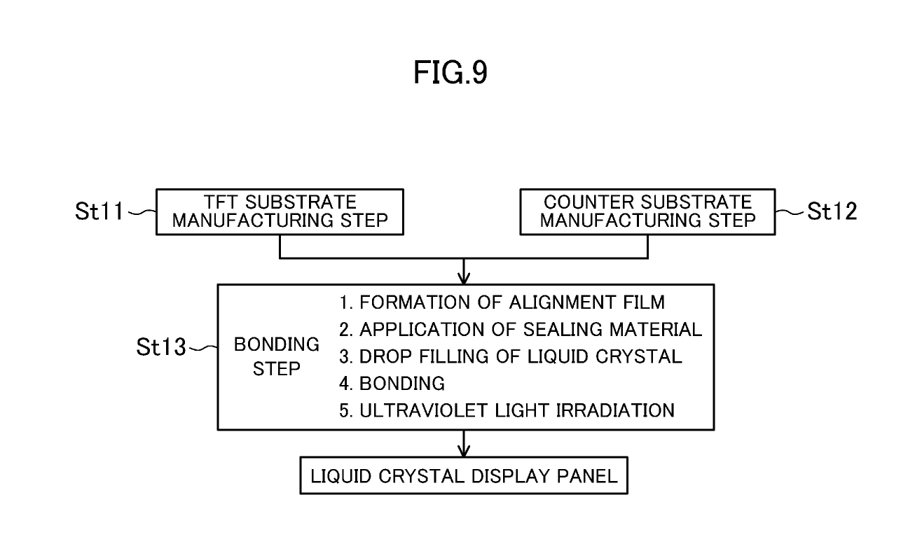

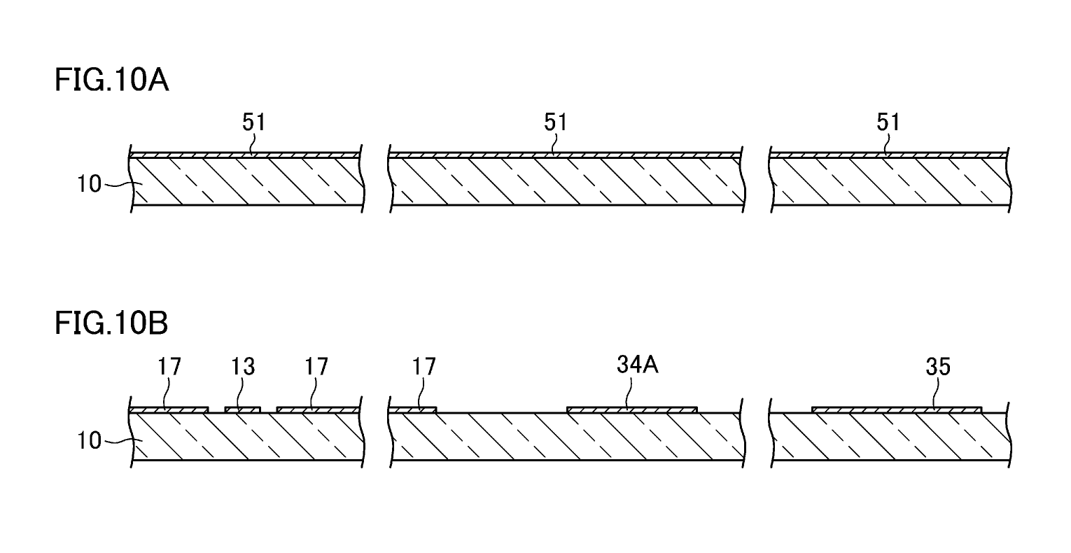

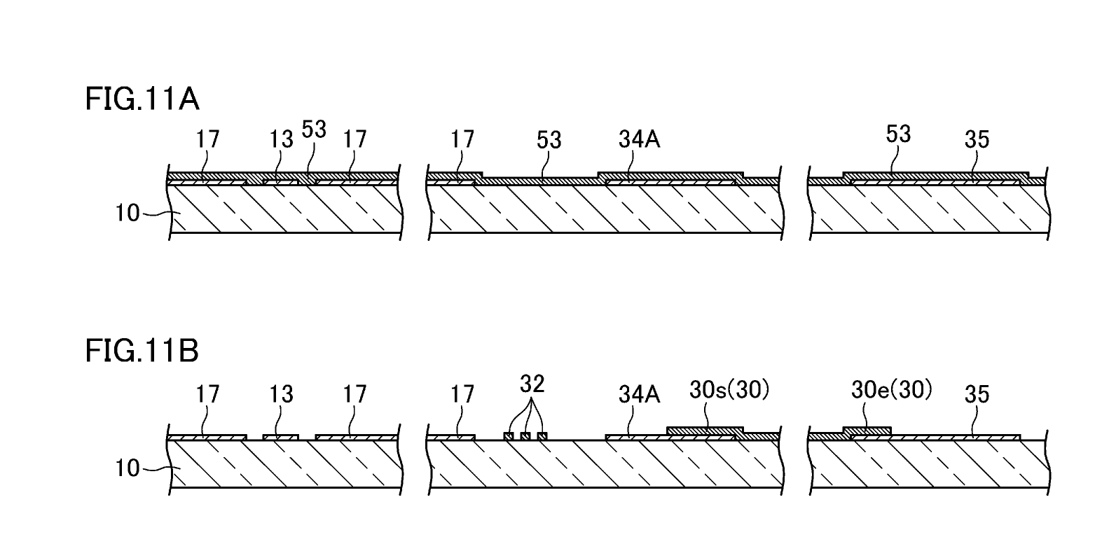

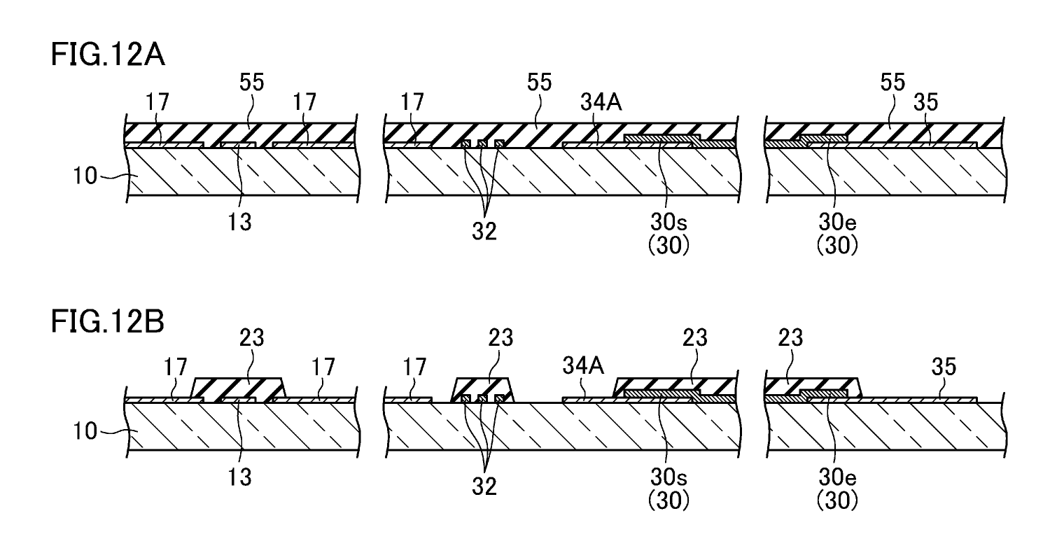

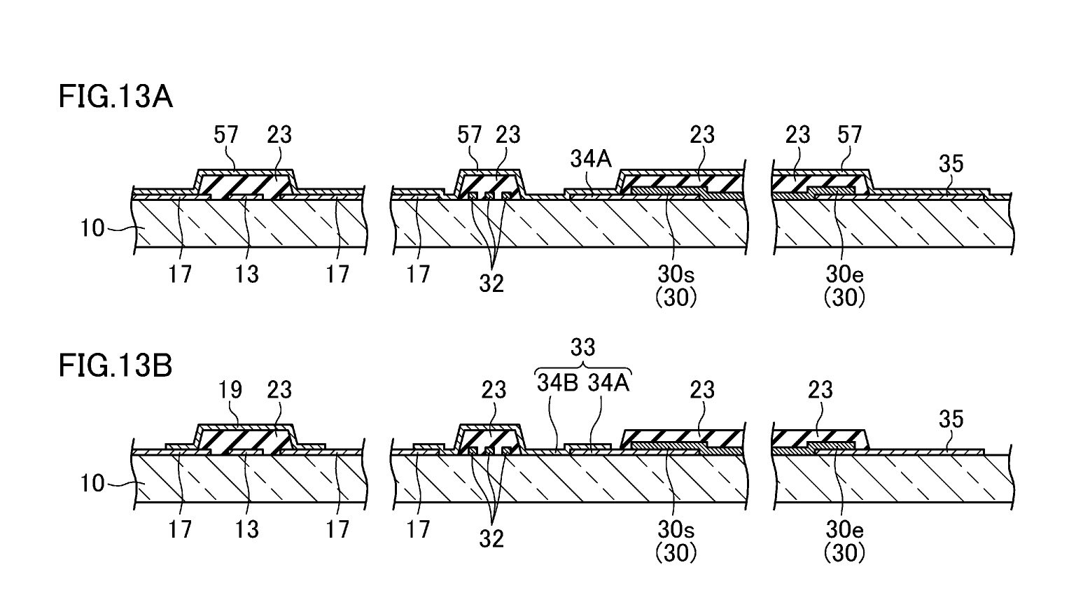

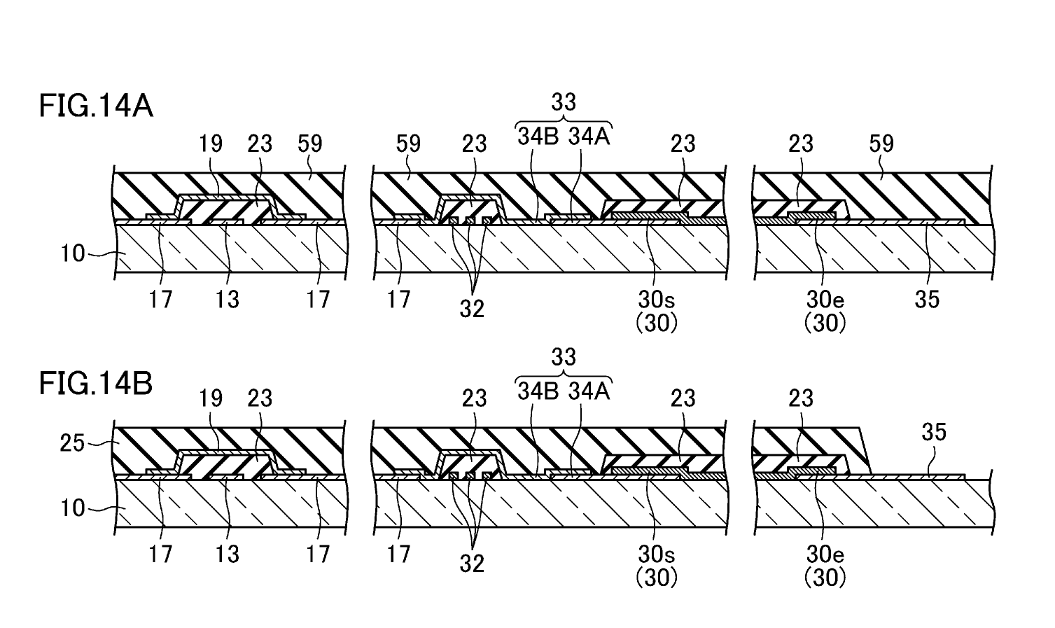

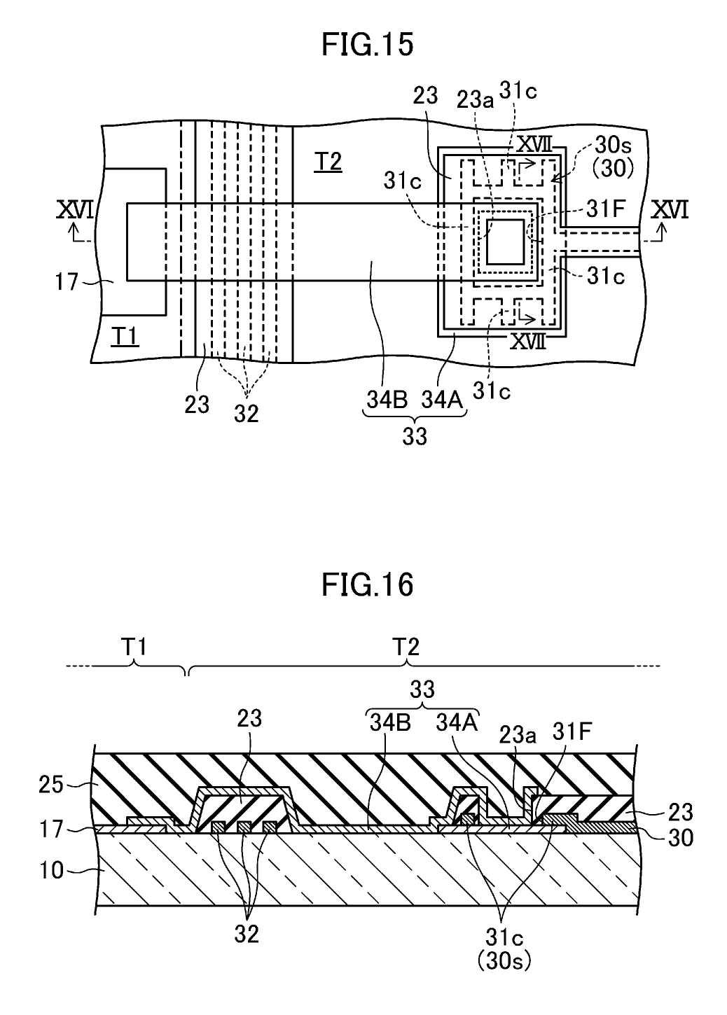

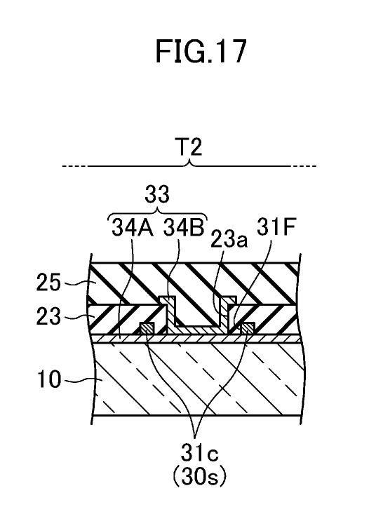

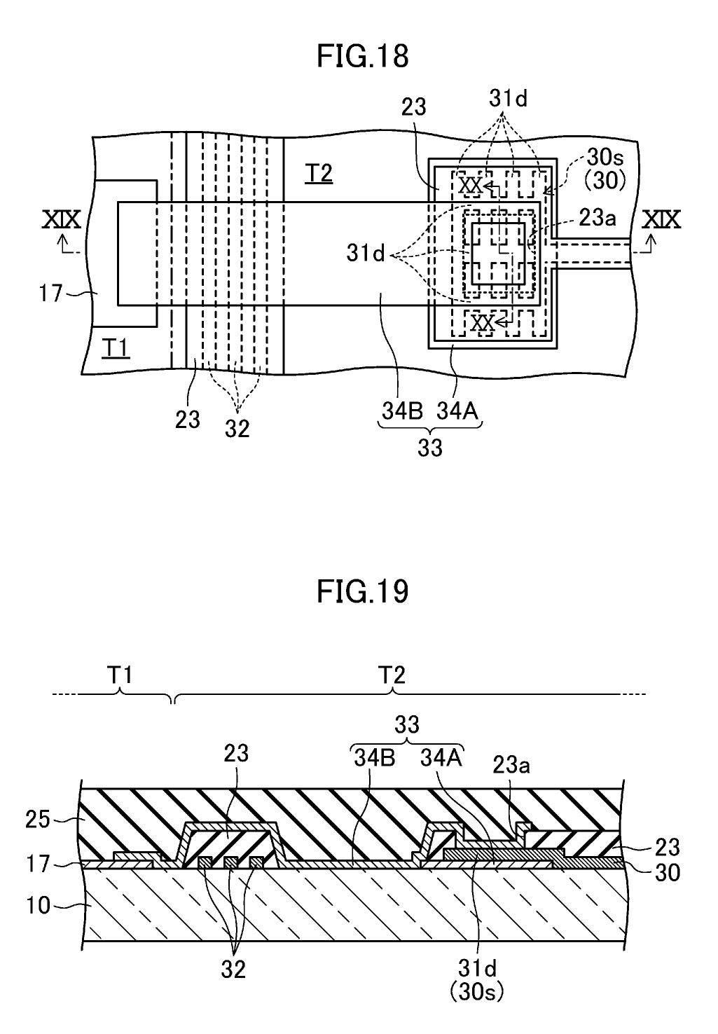

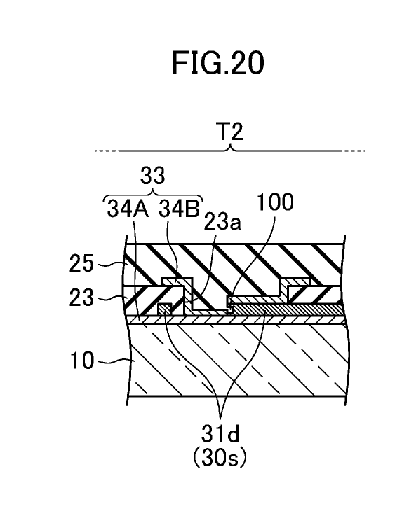

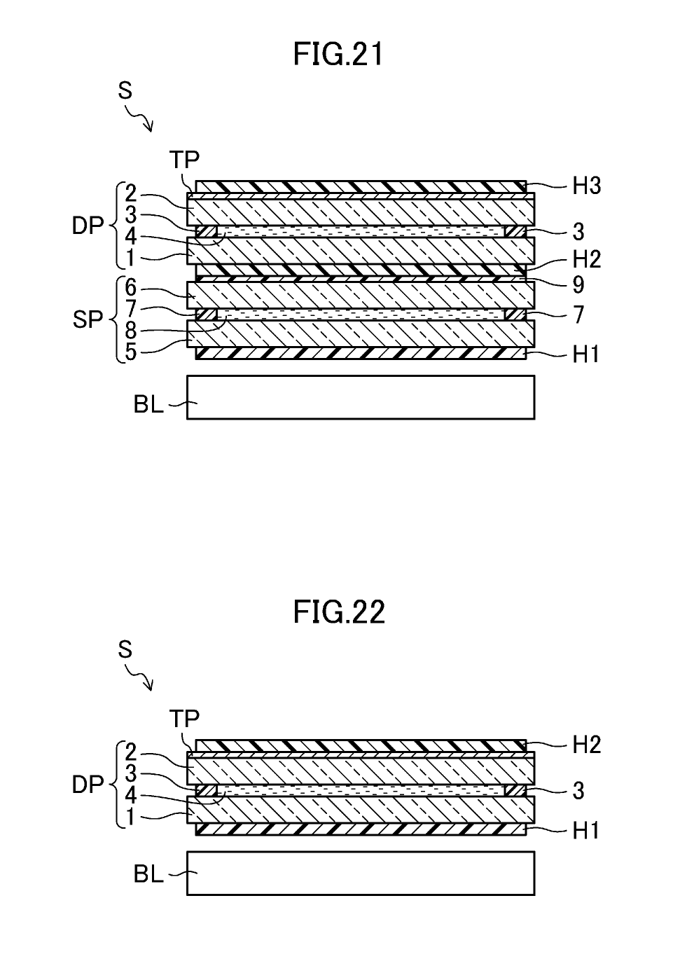

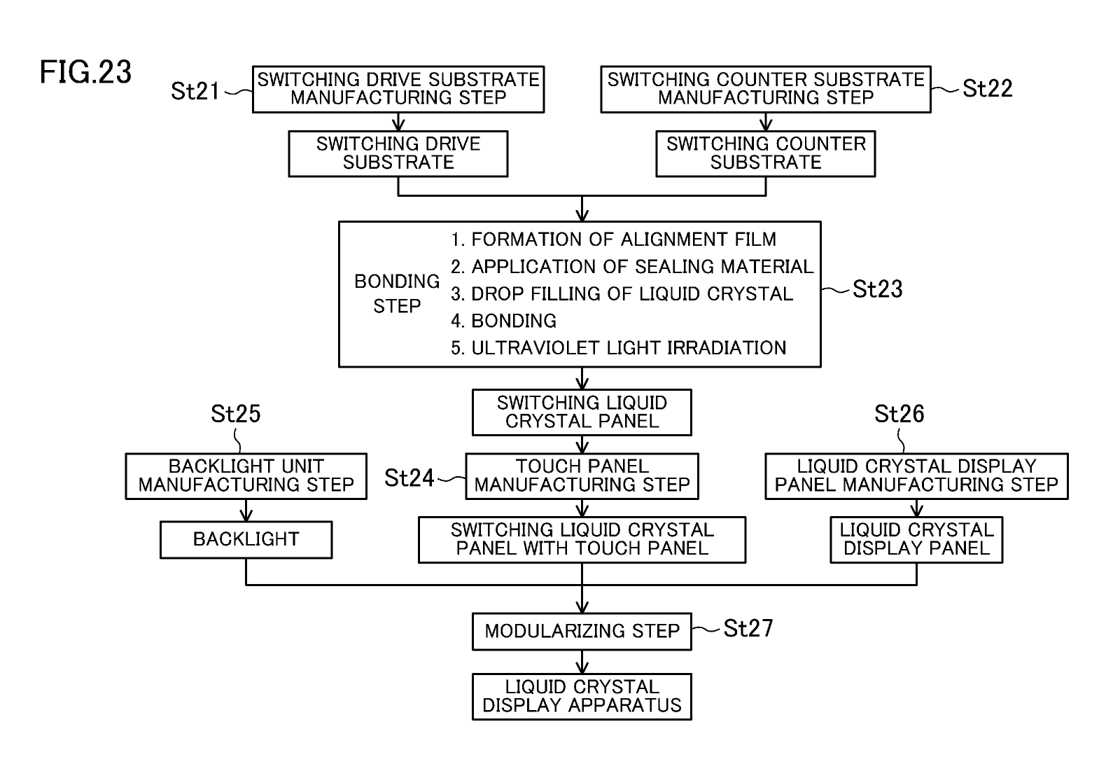

### BRIEF DESCRIPTION OF THE DRAWINGS

[FIG. 1] FIG. 1 is a cross-sectional view schematically illustrating a cross-sectional structure of a 2D/3D switchable liquid crystal display apparatus of a first embodiment.

[FIG. 2] FIG. 2 is a plan view schematically illustrating a touch panel of the first embodiment.

[FIG. 3] FIG. 3 is an enlarged plan view illustrating a connection structure among electrodes for touch position detection and external connection terminals in the touch panel of the first embodiment.

[FIG. 4] FIG. 4 is a cross-sectional view illustrating a cross-sectional structure along an IV-IV line illustrated in FIG. 3.

[FIG. 5] FIG. 5 is a cross-sectional view illustrating a cross-sectional structure along a V-V line illustrated in FIG. 3.

[FIG. 6] FIG. 6 is an enlarged plan view illustrating a connection structure between a conductive connection part and a lead line in the first embodiment.

[FIG. 7] FIG. 7 is a cross-sectional view illustrating a cross-sectional structure along a VII-VII line illustrated in FIG. 6. [FIG. 8] FIG. 8 is a flowchart illustrating a method for manufacturing the 2D/3D switchable liquid crystal display apparatus in the first embodiment.

[FIG. 9] FIG. 9 is a flowchart illustrating the outline of a liquid crystal display panel manufacturing step.

[FIG. 10] FIGS. 10A and 10B are cross-sectional views illustrating a first patterning step of the touch panel manufacturing method of the first embodiment, and sections illustrated in FIGS. 10A and 10B correspond respectively to sections illustrated in FIGS. 4, 5, and 7.

[FIG. 11] FIGS. 11A and 11B are cross-sectional views illustrating a second patterning step of the touch panel manufacturing method of the first embodiment, and sections illustrated in FIGS. 11A and 11B correspond respectively to the sections illustrated in FIGS. 4, 5, and 7.

[FIG. 12] FIGS. 12A and 12B are cross-sectional views illustrating a third patterning step of the touch panel manufacturing method of the first embodiment, and sections illustrated in FIGS. 12A and 12B correspond respectively to the sections illustrated in FIGS. 4, 5, and 7.

[FIG. 13] FIGS. 13A and 13B are cross-sectional views illustrating a fourth patterning step of the touch panel manufacturing method of the first embodiment, and sections illustrated in FIGS. 13A and 13B correspond respectively to the sections illustrated in FIGS. 4, 5, and 7. [FIG. 14] FIGS. 14A and 14B are cross-sectional views illustrating a fifth patterning step of the touch panel manufacturing method of the first embodiment, and sections illustrated in FIGS. 14A and 14B correspond respectively to the sections illustrated in FIGS. 4, 5, and 7.

[FIG. 15] FIG. 15 is an enlarged plan view illustrating a connection structure between a conductive connection part and a lead line in a second embodiment.

[FIG. 16] FIG. 16 is a cross-sectional view illustrating a cross-sectional structure along an XVI-XVI line illustrated in FIG. 15.

[FIG. 17] FIG. 17 is a cross-sectional view illustrating a cross-sectional structure along an XVII-XVII line illustrated in FIG. 15.

[FIG. 18] FIG. 18 is an enlarged plan view illustrating a connection structure between a conductive connection part and a lead line in a third embodiment.

[FIG. 19] FIG. 19 is a cross-sectional view illustrating a cross-sectional structure along an XIX-XIX line illustrated in FIG. 18.

[FIG. 20] FIG. 20 is a cross-sectional view illustrating a cross-sectional structure along an XX-XX line illustrated in FIG. 18.

[FIG. 21] FIG. 21 is a cross-sectional view schematically illustrating a cross-sectional structure of a 2D/3D switchable liquid crystal display apparatus of another embodiment.

[FIG. 22] FIG. 22 is a cross-sectional view schematically illustrating a cross-sectional structure of a liquid crystal display apparatus of still another embodiment.

[FIG. 23] FIG. 23 is a flowchart illustrating a method for manufacturing a 2D/3D switchable liquid crystal display apparatus in still another embodiment.

### DESCRIPTION OF EMBODIMENTS

Embodiments of the present disclosure will be described in detail below with reference to drawings. Note that the present disclosure is not limited to each of the following embodiments.

### First Embodiment of the Invention

In a first embodiment, a 2D/3D switchable liquid crystal display apparatus S configured to switch between a normal two-dimensional plane display (2D plane display) and a three-dimensional stereoscopic display (3D stereoscopic display) will be described as one example of a display apparatus.

Configuration of 2D/3D Switchable Liquid Crystal Display Apparatus S

A cross-sectional structure of the 2D/3D switchable liquid crystal display apparatus S of the present embodiment is illustrated in FIG. 1.

The 2D/3D switchable liquid crystal display apparatus S is a transmissive liquid crystal display apparatus with a touch panel TP. The 2D/3D switchable liquid crystal display apparatus S includes a liquid crystal display panel DP, a backlight unit BL which is a light source device arranged in the back of the liquid crystal display panel DP, a switching liquid crystal panel SP arranged in the front of the liquid crystal display panel DP, i.e., on a side of the liquid crystal display panel DP opposite to the backlight unit BL, and the touch panel TP provided in the front of the switching liquid crystal panel SP.

<Configuration of Liquid Crystal Display Panel DP>

The liquid crystal display panel DP is a display device configured to generate a display image corresponding to input image data. The liquid crystal display panel DP includes a thin film transistor (hereinafter referred to as a “TFT”) substrate 1 and a counter substrate 2 which are arranged so as to face each other, a frame-shaped sealing material 3 bonding the TFT substrate 1 and the counter substrate 2 together at outer peripheral parts thereof, and a liquid crystal layer 4 sealed between the TFT substrate 1 and the counter substrate 2 so as to be surrounded by the sealing material 3.

In a region including an overlap of the TFT substrate 1 and the counter substrate 2 and surrounded by the sealing material 3, i.e., a region where the liquid crystal layer 4 is formed, the liquid crystal display panel DP has a display region D where an image is displayed. In the display region D, a plurality of pixels which are the minimum units of an image are arranged in a matrix. Moreover, the liquid crystal display panel DP has, outside the display region D, a terminal region (not shown in the figure) where the TFT substrate 1 protrudes beyond the counter substrate 2 and is exposed to the outside. In the terminal region, a circuit board such as a flexible printed circuit (FPC) is mounted with an anisotropic conductive film being interposed between the TFT substrate 1 and the circuit board, and a display signal containing image data corresponding to an image to be displayed is input from an external circuit to the liquid crystal display panel DP through the circuit board.

Although not shown in the figure, the TFT substrate 1 includes, on an insulating substrate which is a base substrate such as a glass substrate, a plurality of gate lines provided so as to extend parallel to each other, a plurality of source lines provided so as to extend parallel to each other in a direction crossing the gate lines, TFTs each provided at an intersection of the gate line and the source line, i.e., at a corresponding one of the pixels, and pixel electrodes each connected to a corresponding one of drains of the TFTs. The TFT substrate 1 is configured such that each TFT switches between ON and OFF to selectively apply potential to the pixel electrode corresponding to such a TFT.

Although not shown in the figure, the counter substrate 2 includes, on an insulating substrate which is a base substrate such as a glass substrate, a black matrix provided in a grid pattern corresponding to the gate and source lines, a plurality of color filters which are formed of periodically-arranged red, green, blue layers each provided between adjacent ones of grids of the black matrix and provided for a corresponding one of the pixels, a common electrode provided so as to cover the black matrix and the color filters and facing the group of the pixel electrodes, and columnar photo spacers provided on the common electrode.

The TFT substrate 1 and the counter substrate 2 are formed in, e.g., a rectangular shape. An alignment film (not shown in the figure) is formed on each of opposing inner surfaces of the TFT substrate 1 and the counter substrate 2. A first polarizing plate H1 and a second polarizing plate H2 are provided respectively on outer surfaces of the TFT substrate 1 and the counter substrate 2. A transmission axis of the first polarizing plate H1 on the TFT substrate 1 and a transmission axis of the second polarizing plate H2 on the counter substrate 2 are offset from each other by 90°. The liquid crystal layer 4 is made of, e.g., a nematic liquid crystal material having electrooptical properties.

<Configuration of Backlight Unit BL>

Although not shown in the figure, the backlight unit BL includes a light source such as a light emitting diode (LED) or a cold-cathode tube, a light guide plate, and a plurality of optical sheets such as a reflective sheet, a diffusion sheet, and a prism sheet. The backlight unit BL is configured such that light entering the light guide plate from the light source is, as a uniform planar beam of light, emitted from an exit surface of the light guide plate toward the liquid crystal display panel DP through the optical sheets.

<Configuration of Switching Liquid Crystal Panel SP>

The switching liquid crystal panel SP is a switching device configured to switch between a 2D display state, i.e., a first display state in which a 2D image is displayed, and a 3D display state, i.e., a second display state in which a 3D image is displayed. The switching liquid crystal panel SP is bonded to the liquid crystal display panel DP by an adhesive material 9 such as a double-sided tape. The switching liquid crystal panel SP includes a switching counter substrate 5 and a switching drive substrate 6 which are arranged so as to face each other, a frame-shaped sealing material 7 bonding the switching counter substrate 5 and the switching drive substrate 6 together at outer peripheral parts thereof, and a liquid crystal layer 8 sealed between the switching counter substrate 5 and the switching drive substrate 6 so as to be surrounded by the sealing material 7.

In a region including an overlap of the switching counter substrate 5 and the switching drive substrate 6 and surrounded by the sealing material 7, i.e., a region where the liquid crystal layer 8 is formed, the switching liquid crystal panel SP has a parallax barrier region B overlapping with the display region D. In the parallax barrier region B, the switching liquid crystal panel SP is configured to function, in combination with a later-described third polarizing plate H3, as a parallax barrier in which light shielding parts and light transmissive parts are alternately arranged in a stripe pattern in a screen horizontal direction.

Moreover, the switching liquid crystal panel SP has, outside the parallax barrier region B, a terminal region (not shown in the figure) where the switching drive substrate 6 protrudes beyond the switching counter substrate 5 and is exposed to the outside. In the terminal region, a circuit board such as an FPC is mounted with an anisotropic conductive film being interposed between the switching drive substrate 6 and the circuit board, and a control signal for controlling ON/OFF of a drive state is input from an external circuit to the switching liquid crystal panel SP through the circuit board.

The switching counter substrate 5 is arranged on a side close to the liquid crystal display panel DP. Although not shown in the figure, the switching counter substrate 5 includes, on an insulating substrate which is a base substrate such as a glass substrate, a counter electrode formed across the entirety of the parallax barrier region B.

Although not shown in the figure, the switching drive substrate 6 includes, on an insulating substrate 10 which is a base substrate such as a glass substrate, a plurality of drive electrodes each formed in a linear shape so as to extend in a screen vertical direction and arranged in a stripe pattern at predetermined intervals in the screen horizontal direction so as to extend parallel to each other. The switching drive substrate 6 is configured such that the same potential is simultaneously applied to the drive electrodes.

The switching counter substrate 5 and the switching drive substrate 6 are formed in, e.g., a rectangular shape. An alignment film (not shown in the figure) is formed on each of opposing inner surfaces of the switching counter substrate 5 and the switching drive substrate 6. Moreover, the third polarizing plate H3 is provided on an outer surface of the switching drive substrate 6. A transmission axis of the third polarizing plate H3 on the switching drive substrate 6 is in the same direction as that of the transmission axis of the second polarizing plate H2 on the counter substrate 2. The liquid crystal layer 8 is made of, e.g., a nematic liquid crystal material having electrooptical properties.

<Display Operation of 2D/3D Switchable Liquid Crystal Display Apparatus S>

In the liquid crystal display apparatus S having the foregoing configuration, an image is displayed in either one of the 2D display state in which a normal 2D image is displayed or the 3D display state in which an 3D image is displayed by parallax between images from different points of view, i.e., right and left eyes of a viewer.

In a display operation of the liquid crystal display apparatus S, when a gate signal is, in the liquid crystal display panel DP, sequentially output to each of the gate lines to drive the gate lines, and the TFTs connected respectively to the driven gate lines are turned ON all together, a source signal is transmitted to each of the TFTs in an ON state through a corresponding one of the source lines, and predetermined charge is written in each of the pixel electrodes through a corresponding one of the TFTs. Such selective writing of charge in the pixel electrodes is, in a line sequential manner, performed for all lines of the pixels forming the display region D. In such a state, a potential difference is generated between each pixel electrode of the TFT substrate 1 and a counter electrode of the counter substrate 2, and predetermined voltage is applied to the liquid crystal layer. Then, in the liquid crystal display panel DP, an alignment state of liquid crystal molecules is changed depending on the magnitude of voltage to be applied to the liquid crystal layer 4, and the transmittance of light from the backlight unit BL in the liquid crystal layer 4 is adjusted. In such a manner, an image is displayed.

In the 3D display state of the display operation, a compound image formed such that a right-eye image and a left-eye image are each divided into a plurality of lines in the screen horizontal direction and the lines of the right-eye image and the lines of the left-eye image are alternately arranged is displayed on the liquid crystal display panel DP.

Meanwhile, a driving state of the switching liquid crystal panel SP is turned ON, and potential different from that of the counter electrode is applied to each drive electrode. In such a state, a potential difference is generated between each drive electrode and the counter electrode, and predetermined voltage is applied to a region of the liquid crystal layer 8 corresponding to each drive electrode. Then, a polarization axis of light which passed through the region corresponding to each drive electrode is shifted by 90° with respect to a polarization axis of light which passed through a clearance between adjacent ones of the drive electrodes. Thus, when the driving state of the switching liquid crystal panel SP is turned ON, the polarization axis of light which passed through the clearance between adjacent ones of the drive electrodes of the switching liquid crystal panel SP is parallel to the transmission axis of the second polarizing plate H2, and therefore such light passes through the third polarizing plate H3. On the other hand, the polarization axis of light which passed through the region corresponding to each drive electrode forms an angle of 90° with respect to the transmission axis of the third polarizing plate H3, and therefore such light does not pass through the third polarizing plate H3.

In the present embodiment, an optical effect due to a relationship between the switching liquid crystal panel SP and the third polarizing plate H3 causes the region of the switching liquid crystal panel SP corresponding to each drive electrode to serve as the light shielding part, and causes the region of the switching liquid crystal panel SP between adjacent ones of the drive electrodes to serve as the light transmissive part. The switching liquid crystal panel SP fulfills an effective function as the parallax barrier in which the light shielding parts and the light transmissive parts are alternately arranged in a stripe pattern in the screen horizontal direction. That is, the combination of the switching liquid crystal panel SP and the third polarizing plate H3 forms parallax barrier means of the present disclosure.

A 3D image is displayed in the following manner: a compound image formed of right-eye and left-eye images and displayed on the liquid crystal display panel DP is, through the parallax barrier formed of the switching liquid crystal panel SP and the third polarizing plate H3, separated into the right-eye and left-eye images whose angles of view are different from each other such that a viewer views images from different points of view with his right and left eyes. That is, in the liquid crystal display panel DP, a region formed of the pixels corresponding to the right-eye image and a region formed of the pixels corresponding to the left-eye image are first and second display regions of the present disclosure, respectively.

On the other hand, in the 2D display state of the display operation, a normal 2D plane image is displayed on the liquid crystal display panel DP. Moreover, the driving state of the switching liquid crystal panel SP is turned OFF, and the same potential is applied to each drive electrode and the counter electrode. In such a manner, the function of the switching liquid crystal panel SP as the parallax barrier is invalidated, and therefore incident light is output without a change in polarization axis thereof. As a result, a viewer views the same image with his both eyes, and therefore a 2D image is displayed.

<Configuration of Touch Panel TP>

The configuration of the touch panel TP is illustrated in FIGS. 2-7. FIG. 2 is a schematic plan view of the touch panel TP. FIG. 3 is an enlarged plan view illustrating a connection structure among touch position detection electrodes 11, 17 and external connection terminals 35 in the touch panel TP. FIG. 4 is a cross-sectional view illustrating a cross-sectional structure along an IV-IV line illustrated in FIG. 3. FIG. 5 is a cross-sectional view illustrating a cross-sectional structure along a V-V line illustrated in FIG. 3. FIG. 6 is an enlarged plan view illustrating a connection structure between a conductive connection part 33 and a lead line 30. FIG. 7 is a cross-sectional view illustrating a cross-sectional structure along a VII-VII line illustrated in FIG. 6.

The touch panel TP of the present embodiment is formed directly on a surface of the switching drive substrate 6 forming the switching liquid crystal panel SP, and the entirety of the liquid crystal display apparatus S with the touch panel TP is configured to have a small thickness. The touch panel TP is a projected capacitive touch panel. Referring to FIG. 2, the touch panel TP has a touch region T1 which is, e.g., a rectangular region where a touch position at which the touch panel TP had contact with a contact body (e.g., a finger of a user) is detected, a frame region T2 which is, e.g., a rectangular frame-shaped region formed around the touch region T1 such that a touch position is not detectable, and a terminal region T3 formed on one side (right side as viewed in FIG. 2) of the frame region T2 along an edge of the switching drive substrate 6. The touch region T1 is arranged corresponding to the display region D of the liquid crystal display panel DP, and the frame region T2 is arranged corresponding to a non-display region of the liquid crystal display panel DP.

The touch panel TP includes the touch position detection electrodes 11, 17 arranged in the touch region T1, the plurality of lead lines 30 each electrically connected to a corresponding one of the touch position detection electrodes 11, 17 and extending from the touch region T1 toward the terminal region T3 on the frame region T2, a ground line 32 which is a peripheral line extending around the touch region T1 so as to pass between the lead line 30 and the touch position detection electrode 11, 17, the conductive connection parts 33 each provided in a corresponding one of base end parts of the lead lines 30, the external connection terminals 35 each provided in a corresponding one of tip end parts of the lead lines 30 and arranged in the terminal region T3, and a controller 41 which is an external circuit electrically connected to the external connection terminals 35.

<Configuration of Touch Position Detection Electrodes 11, 17>

The touch position detection electrodes 11, 17 are a plurality of first electrodes 11 (electrodes indicated by shaded parts in FIG. 2) arranged in a matrix and a plurality of second electrodes 17 (electrodes indicated by non-shaded parts in FIG. 2) arranged in a matrix. The first and second electrodes 11, 17 are, referring to FIG. 2, alternately arranged in a diagonal direction so as to form a honeycomb arrangement.

The first electrodes 11 are each formed in, e.g., a substantially rectangular shape, and are arranged at predetermined intervals such that adjacent ones of corners of the first electrodes 11 in the horizontal direction (X-axis direction) as viewed in FIG. 2 face each other and adjacent ones of the corners of the first electrodes 11 in the vertical direction (Y-axis direction) as viewed in FIG. 2 face each other. Referring to FIG. 3, the first electrodes 11 arranged in the X-axis direction are integrally formed such that adjacent ones of the first electrodes 11 are connected together through a first connection part 13, thereby forming a first electrode group 15. That is, the first electrodes 11 and the first connection parts 13 are alternately arranged in the X-axis direction, and plural lines of the first electrode groups 15 each including the first electrodes 11 connected together through the first connection parts 13 are arranged parallel to each other in the Y-axis direction. The first electrode 11 and the first connection part 13 are made of a transparent conductive oxide such as an ITO or an indium zinc oxide (hereinafter referred to as an “IZO”).

Similarly, the second electrodes 17 are each formed in, e.g., a substantially rectangular shape, and are arranged at predetermined intervals such that adjacent ones of corners of the second electrodes 17 in the X-axis direction face each other and adjacent ones of the corners of the second electrodes 17 in the Y-axis direction face each other. The second electrodes 17 arranged in the Y-axis direction are electrically connected together such that adjacent ones of the second electrodes 17 are connected together through a second connection part 19, thereby forming a second electrode group 21. That is, the second electrodes 17 and the second connection parts 19 are alternately arranged in the Y-axis direction, and plural lines of the second electrode groups 21 each including the second electrodes 17 electrically connected together through the second connection parts 19 are arranged parallel to each other in the X-axis direction. The second electrodes 17 and the second connection parts 19 are made of a transparent conductive oxide such as an ITO or an IZO.

Referring to FIG. 4, the first electrode groups 15 (first electrodes 11), the first connection parts 13, and the second electrode groups 21 (second electrodes 17) are formed on an outer surface of the insulating substrate 10 forming the switching counter substrate 5. Only the first connection parts 13 are each covered by an island-shaped interlayer insulating film 23. On the other hand, the second connection parts 19 each have a bridged structure in which the second connection part 19 extends in a direction crossing the first connection part 13 on the interlayer insulating film 23 and crosses over the first connection part 13 with the interlayer insulating film 23 being interposed between the second connection part 19 and the first connection part 13. Each end part of the second connection part 19 is connected to a corresponding one of the corners of the second electrodes 17.

In the present embodiment, since the first electrode groups 15 and the second electrode groups 21 are provided in the same layer, the substantially same degree of change in electrostatic capacitance formed between each of the first and second electrodes 11, 17 at a touch position and a contact body such as a finger can occur. Thus, a difference in sensitivity to a change in electrostatic capacitance between the first and second electrodes 11, 17 can be reduced, and therefore a touch position can be detected with good sensitivity.

Note that, in the present embodiment, the first electrode groups 15 (first electrodes 11), the first connection parts 13, and the second electrode groups 21 (second electrodes 17) form a first conductive pattern for touch position detection in the present disclosure, and the second connection parts 19 form a second conductive pattern for touch position detection in the present disclosure.

The first electrode groups 15 (first electrodes 11), the second electrode groups 21 (second electrodes 17), the second connection parts 19, and the interlayer insulating film 23 are covered by a protective insulating film 25. The protective insulating film 25 is made of an acrylic-based organic insulating material. Referring to FIGS. 3 and 5, the protective insulating film 25 is not formed on the terminal region T3, and the external connection terminals 35 are exposed to the outside.

<Configuration of Lead Line 30>

Referring to FIG. 3, many lead lines 30 extend from the periphery of the touch region T1 to the proximity of the terminal region T3 so as to be arranged next to each other. The lead lines 30 are covered by the interlayer insulating film 23 and the protective insulating film 25. Referring to FIG. 5, the entirety of each lead line 30 is arranged inside relative to outer edges of the insulating films 23, 25. Thus, two layers of the insulating films, i.e., the interlayer insulating film 23 and the protective insulating film 25, prevent moisture etc. from entering the lead line 30 from the outside, thereby successfully reducing or preventing corrosion of the lead line 30.

Referring to FIG. 3, a base end part 30s and a tip end part 30e of the lead line 30 are formed so as to have a larger width than that of a middle part of the lead line 30 between the end parts 30s, 30e. Thus, as compared to the case where the end parts 30s, 30e of the lead line 30 are formed so as to have a width equal to or smaller than that of the middle part of the lead line 30, a connection area between the base end part 30s of the lead line 30 and the conductive connection part 33 and a connection area between the tip end part 30e of the lead line 30 and the external connection terminal 35 are increased, and therefore conductivity of the conductive connection part 33 and the external connection terminal 35 with the lead line 30 can be improved. Moreover, a margin for displacement of the formation positions of the conductive connection part 33 and the external connection terminal 35 with respect to the lead line 30 is ensured.

Referring to FIG. 6, a plurality of thin line parts 31a, 31b integrally formed such that a clearance is formed between adjacent ones of the thin line parts 31a, 31b form the base end part 30s of the lead line 30. Specifically, the base end part 30s of the lead line 30 in the present embodiment includes the thin trunk part 31a extending from the middle part of the lead line 30, and the plurality of thin branch parts 31b protruding from the thin trunk part 31a toward both sides so as to be apart from each other.

Each lead line 30 has a multilayer structure in which a high-melting metal layer, an aluminum (Al) layer, and a high-melting metal layer are stacked on each other in this order. For example, the following layers may be stacked on each other in the order described below: a molybdenum niobium alloy (MoNb) layer, an aluminum (Al) layer, and a molybdenum niobium alloy (MoNb) layer; a molybdenum nitride (MoN) layer, an aluminum (Al) layer, and a molybdenum nitride (MoN) layer; or a molybdenum (Mo) layer, an aluminum (Al) layer, and a molybdenum (Mo) layer.

<Configuration of Ground Line 32>

The ground line 32 extends around the touch region T1 as illustrated in FIG. 3, and functions as a shield for blocking electromagnetic waves. Note that the ground line 32 is illustrated as a single line in FIG. 3, but the ground line 32 is, referring to FIG. 6, branched into a plurality of thin lines (e.g., three thin lines). The ground line 32 is formed of the same film as that of the lead line 30, and has a multilayer structure (e.g., MoNb/Al/MoNb, MoN/Al/MoN, or Mo/Al/Mo) similar to that of the lead line 30. Similarly to the lead line 30, the entirety of the ground line 32 is covered by the interlayer insulating film 23.

<Configuration of Conductive Connection Part 33 and External Connection Terminal 35>

Referring to FIG. 3, the conductive connection part 33 is connected to the base end part 30s of the lead line 30, and is connected to the first electrode group 15 or the second electrode group 21. Many conductive connection parts 33 are arranged in the periphery of the touch region T1. Referring to FIGS. 6 and 7, a first connection layer 34A and a second connection layer 34B form each conductive connection part 33, and each conductive connection part 33 has a serial connection structure in which the first and second connection layers 34A, 34B are connected to the lead line 30 in series.

The first connection layer 34A is formed below the interlayer insulating film 23, specifically below the lead line 30. The base end part 30s of the lead line 30 is stacked on the first connection layer 34A, and the first connection layer 34A is connected to a lower surface of the base end part 30s of the lead line 30. The first connection layer 34A protrudes from a region overlapping with the base end part 30s of the lead line 30 toward an outer region on a side close to the touch region T1. On the other hand, the second connection layer 34B is connected to the first connection layer 34A so as to partially overlap with the protrusion of the first connection layer 34A. The second connection layer 34B has a bridged structure in which the second connection layer 34B extends in a direction crossing the ground line 32 and crosses over the ground line 32 with the interlayer insulating film 23 being interposed between the second connection layer 34B and the ground line 32. The second connection layer 34B is connected to the first electrode 11 positioned in one of the outermost end parts of the first electrode group 15 or the second electrode 17 positioned in one of the outermost end parts of the second electrode group 21 so as to partially overlap with the first electrode 11 or the second electrode 17.

According to the foregoing serial connection structure, it can be ensured that the conductive connection part 33 and the lead line 30 are connected together in the configuration in which the ground line 32 extending around the touch region T1 and the conductive connection parts 33 are insulated from each other by the interlayer insulating film 23. That is, since the first connection layer 34A is, below the lead line 30, connected so as to overlap with the base end part 30s of the lead line 30, it can be ensured that the conductive connection part 33 and the lead line 30 are connected together through the first connection layer 34A. Moreover, since the second connection layer 34B crossing over the ground line 32 with the interlayer insulating film 23 being interposed between the second connection layer 34B and the ground line 32 is connected to the first connection layer 34A, the second connection layer 34B insulates the conductive connection part 33 and the ground line 32 from each other.

It is not necessary to form a contact hole in part of the interlayer insulating film 23 corresponding to the lead line 30. Thus, the entirety of the lead line 30 can be covered by the interlayer insulating film 23, and therefore dissolving of the lead line 30 with a developer used for forming the interlayer insulating film 23 can be avoided. This reduces or prevents losing of part of the lead line 30 and therefore peeling of the lead line 30 due to the losing of part of the lead line 30. In such a state that the lead line 30 is successfully formed, it can be ensured that the conductive connection part 33 and the lead line 30 are connected together.

Referring to FIG. 3, the external connection terminals 35 are each connected to a corresponding one of the tip end parts 30e of the lead lines 30, and are densely arranged in the terminal region T3 in the state in which the external connection terminals 35 are drawn to outside the interlayer insulating film 23 and the protective insulating film 25. Each external connection terminal 35 is, referring to FIG. 5, provided below a corresponding one of the lead lines 30, and is connected to a lower surface of such a lead line 30. Moreover, each external connection terminal 35 protrudes from a region where the interlayer insulating film 23 and the protective insulating film 25 are formed, toward the terminal region T3 outside such a region.

Although details will be described later, the first connection layers 34A and the external connection terminals 35 are formed of the same film as that of the first electrode groups 15 (first electrodes 11), the first connection parts 13, and the second electrode groups 21 (second electrodes 17), and the second connection layers 34B are formed of the same film as that of the second connection parts 19.

<Configuration of Controller 41>

The controller 41 is mounted on the terminal region T3 as, e.g., a driver integrated circuit formed by a technique called “tape automated bonding (TAB).” The controller 41 includes, as a detection circuit 43, an electrostatic capacitance detection circuit configured to detect, upon touch of the touch region T1 by a contact body, a change in electrostatic capacitance formed between each of the first and second electrodes 11, 17 at a touch position and the contact body, or an impedance detection circuit configured to detect, upon touch, an impedance change occurring in each of the first and second electrodes 11, 17 at a touch position. The controller 41 is configured to compare signals which are output from the external connection terminals 35 via the conductive connection parts 33 and the lead lines 30 and which are detected by the detection circuit 43 to detect a touch position of a contact body and movement of the touch position in the touch region T1.

Manufacturing Method

Next, an example of a method for manufacturing the 2D/3D switchable liquid crystal display apparatus S with the touch panel TP will be described with reference to FIGS. 8 and 9. In the present embodiment, a manufacturing method employing single wafer processing by which a single switching counter substrate 5 and a single switching drive substrate 6 are manufactured and are bonded together to manufacture a single switching liquid crystal panel SP will be described as an example. However, the present disclosure is also applicable to a manufacturing method employing gang printing by which a mother panel including a plurality of cell units is prepared and is cut into the cell units to simultaneously form a plurality of switching liquid crystal panels SP. The same applies to the liquid crystal display panel DP.

FIG. 8 is a flowchart illustrating the method for manufacturing the 2D/3D switchable liquid crystal display apparatus S with the touch panel TP. The method for manufacturing the 2D/3D switchable liquid crystal display apparatus S with the touch panel TP includes a touch panel manufacturing step St01, a switching drive substrate manufacturing step St02, a switching counter substrate manufacturing step St03, a bonding step St04, a backlight unit manufacturing step St05, a liquid crystal display panel manufacturing step St06, and a modularizing step St07.

<Touch Panel Manufacturing Step St01>

By repeating publicly-known photolithography, first electrodes 11, first connection parts 13, second electrodes 17, lead lines 30, an interlayer insulating film 23, second connection parts 19, conductive connection parts 33 (first connection layers 34A and second connection layers 34B), external connection terminals 35, and a protective insulating film 25 are formed on an insulating substrate 10 prepared in advance, such as a glass substrate. In such a manner, a touch panel TP is manufactured.

<Switching Drive Substrate Manufacturing Step St02>

Drive electrodes etc. are, by publicly-known photolithography, formed on a back surface of the insulating substrate 10 on which the touch panel TP is formed. In such a manner, a switching drive substrate 6 with the touch panel TP is manufactured.

<Switching Counter Substrate Manufacturing Step St03>

By publicly-known photolithography, a counter electrode etc. are formed on an insulating substrate prepared in advance, such as a glass substrate. In such a manner, a switching counter substrate 5 is manufactured.

<Bonding Step St04>

An alignment film is, by, e.g., printing, formed on each surface of the switching counter substrate 5 and the switching drive substrate 6, and then rubbing is performed as necessary. Next, a sealing material 7 made of an ultraviolet curable resin is applied in a frame shape by, e.g., a dispenser, and the predetermined amount of a liquid crystal material is dropped onto a region surrounded by the sealing material 7.

The switching counter substrate 5 and the switching drive substrate 6 are, under reduced pressure, joined together with the sealing material 7 and the liquid crystal material being interposed therebetween, thereby forming a liquid crystal layer 8. Then, in such a manner that the joined body is exposed to atmospheric pressure, pressure is applied to surfaces of the joined body. In such a state, the sealing material 7 is cured by ultraviolet light irradiation, and the switching counter substrate 5 and the switching drive substrate 6 are bonded together. In the foregoing manner, a switching liquid crystal panel SP is formed.

In the foregoing state, a base end part 30s of the lead line 30 is formed so as to have a large width at the position overlapping with the sealing material 7, but a plurality of thin line parts 31a, 31b integrally formed such that a clearance is formed between adjacent ones of the thin line parts 31a, 31b form the base end part 30s of the lead line 30. Thus, the sealing material 7 can be irradiated with ultraviolet light through the clearance between adjacent ones of the thin line parts 31a, 31b, and therefore an uncured part of the sealing material 7 can be reduced. This increases the bonding strength of the substrates 5, 6, and reduces or prevents entering of a component(s) of the uncured part of the sealing material 7 into the liquid crystal layer 8. Thus, degradation of a display quality due to instability of an alignment state of liquid crystal molecules or occurrence of blurring or unevenness in a displayed image can be reduced or prevented.

Then, if there are a clearance between the switching counter substrate 5 and the switching drive substrate 6 outside the sealing material 7, the clearance is, as necessary, filled with a sealing material 7, and then the sealing material 7 is cured. Subsequently, a third polarizing plate H3 is bonded to an outer surface of the switching drive substrate 6.

<Backlight Unit Manufacturing Step St05>

First, an acrylic resin plate to be a base of a light guide plate is molded by, e.g., a publicly-known injection molding device, and, e.g., a dot pattern for scattering light is formed on the acrylic resin plate. In such a manner, the light guide plate is manufactured. Next, optical sheets such as a reflective film, a diffusion sheet, and a prism sheet are bonded to the light guide plate. Subsequently, in such a manner that a light source such as an LED or a cold-cathode tube is attached to the bonded body of the light guide plate and the optical sheets, a backlight unit BL is manufactured.

<Liquid Crystal Display Panel Manufacturing Step St06>

FIG. 9 is a flowchart illustrating the outline of the liquid crystal display panel manufacturing step St06. The liquid crystal display panel manufacturing step St06 includes a TFT substrate manufacturing step St11, a counter substrate manufacturing step St12, and a bonding step St13.

<TFT Substrate Manufacturing Step St11>

By a publicly-known method in which photolithography is repeated, gate lines, source lines, TFTs, and pixel electrodes are formed on an insulating substrate prepared in advance, such as a glass substrate. In such a manner, a TFT substrate 1 is manufactured.

<Counter Substrate Manufacturing Step St12>

By a publicly-known method in which photolithography is repeated, a black matrix, color filters, a common electrode, and photo spacers are formed on an insulating substrate prepared in advance, such as a glass substrate. In such a manner, a counter substrate 2 is manufactured.

<Bonding Step St13>

An alignment film is, by printing, formed on each surface of the TFT substrate 1 and the counter substrate 2, and then rubbing is performed as necessary. Next, a sealing material 3 made of an ultraviolet curable resin is applied in a frame shape by, e.g., a dispenser, and the predetermined amount of a liquid crystal material is dropped onto a region surrounded by the sealing material 3. Subsequently, the TFT substrate 1 and the counter substrate 2 are, under reduced pressure, joined together with the sealing material 3 and the liquid crystal material being interposed therebetween, thereby forming a liquid crystal layer 4. Then, in such a manner that the joined body is exposed to atmospheric pressure, pressure is applied to surfaces of the joined body. In such a state, the sealing material 3 is cured by ultraviolet light irradiation, and the TFT substrate 1 and the counter substrate 2 are bonded together. In the foregoing manner, a liquid crystal display panel DP is manufactured.

Then, if there is a clearance between the TFT substrate 1 and the counter substrate 2 outside the sealing material 3, the clearance is, as necessary, filled with a sealing material 3, and the sealing material 3 is cured. Subsequently, a first polarizing plate H1 and a second polarizing plate H2 are bonded to both surfaces of the bonded body, i.e., outer surfaces of the TFT substrate 1 and the counter substrate 2, respectively.

<Modularizing Step St07>

A circuit board such as an FPC is mounted on each terminal region of the liquid crystal display panel DP and the switching liquid crystal panel SP with an anisotropic conductive film being interposed between the circuit board and each of the liquid crystal display panel DP and the switching liquid crystal panel SP. Moreover, a controller 41 is mounted on a terminal region T3 of the touch panel TP. The liquid crystal display panel DP and the switching liquid crystal panel SP are bonded together by an adhesive material 9 such as a double-sided tape, and the backlight unit BL is arranged at the back of the liquid crystal display panel DP. The liquid crystal display panel DP, the switching liquid crystal panel SP with the touch panel TP, and the backlight unit BL are modularized.

The foregoing steps are performed to manufacture a 2D/3D switchable liquid crystal display apparatus S with the touch panel TP as illustrated in FIG. 1.

Since the 2D/3D switchable liquid crystal display apparatus S with the touch panel TP, particularly the touch panel TP, has features in the configuration thereof, the touch panel manufacturing step St01 will be described in detail below with reference to FIGS. 10-14. The touch panel manufacturing step St01 includes first to fifth patterning steps. FIGS. 10-14 sequentially illustrate the first to fifth patterning steps of the touch panel manufacturing step. Note that sections illustrated in each of FIGS. 10-14 corresponds, in the order from the left, to sections illustrated in FIGS. 4, 7, and 5, respectively.

<First Patterning Step>

First, e.g., a transparent conductive film 51 made of an ITO or an IZO is, by sputtering, formed on an insulating substrate 10 as illustrated in FIG. 10A. Then, the transparent conductive film 51 is patterned by using a first photo mask, thereby forming, referring to FIG. 10B, first electrodes 11, first connection parts 13, second electrodes 17, first connection layers 34A, and external connection terminals 35. In such a manner, first electrode groups 15 and second electrode groups 21 are formed.

<Second Patterning Step>

On the substrate on which the first electrode groups 15 (first electrodes 11), the first connection parts 13, the second electrode groups 21 (second electrodes 17), the first connection layers 34A, and the external connection terminals 35 are formed, e.g., the following films are, by sputtering, formed in the order described below so as to cover the foregoing components: a molybdenum niobium alloy (MoNb) film, an aluminum (Al) film, and a molybdenum niobium alloy (MoNb) film; a molybdenum nitride (MoN) film, an aluminum (Al) film, and a molybdenum nitride (MoN) film; or a molybdenum (Mo) film, an aluminum (Al) film, and a molybdenum (Mo) film. In such a manner, a multilayer metal film 53 illustrated in FIG. 11A is formed. Subsequently, in such a manner that the multilayer metal film 53 is patterned by using a second photo mask, lead lines 30 are, referring to FIG. 11B, formed such that each base end part 30s is connected so as to overlap with a corresponding one of the first connection layers 34A and that each tip end part 30e is connected so as to overlap with a corresponding one of the external connection terminals 35. Moreover, a ground line 32 is formed.

<Third Patterning Step>

On the substrate on which the lead lines 30 and the ground line 32 are formed, e.g., an insulating film 55 made of a silicon nitride (SiN) as illustrated in FIG. 12A is, by chemical vapor deposition (CVD), formed so as to cover the first electrode groups 15 (first electrodes 11), the first connection parts 13, the second electrode groups 21 (second electrodes 17), the first connection layers 34A, the lead lines 30, and the ground line 32. Subsequently, in such a manner that the insulating film 55 is patterned by using a third photo mask, the first electrode groups 15 and the second electrode groups 21 are, referring to FIG. 12B, exposed and the first connection layers 34A and the external connection terminals 35 are partially exposed. As a result, an interlayer insulating film 23 covering the first connection parts 13, the lead lines 30, and the ground line 32 is formed from the insulating film 55.

<Fourth Patterning Step>

Referring to FIG. 13A, a transparent conductive film 57 made of, e.g., an ITO or an IZO is, by sputtering, formed on the substrate on which the interlayer insulating film 23 is formed. Then, in such a manner that the transparent conductive film 57 is patterned by using a fourth photo mask, each second connection part 19 is, referring to FIG. 13B, formed so as to cross over the interlayer insulating film 23 and to connect adjacent ones of the second electrodes 17 in the same second electrode group 21, and each second connection layer 34B is formed so as to cross over the interlayer insulating film 23 with part of the second connection layer 34B overlapping with the first connection layer 34A and the touch position detection electrode (i.e., the first electrode 11 or the second electrode 17) and to connect the first connection layer 34A and the touch position detection electrode together. In the foregoing manner, conductive connection parts 33 are formed.

<Fifth Patterning Step>

On the substrate on which the second connection parts 19 and the second connection layers 34B are formed, an insulating film 59 made of, e.g., an acrylic-based organic insulating film material as illustrated in FIG. 14A is, by spin coating or slit coating, formed so as to cover the second connection parts 19 and the second connection layers 34B. Subsequently, in such a manner that the insulating film 59 is patterned by using a fifth photo mask, part of the insulating film 59 in the terminal region T3 is removed, and the external connection terminals 35 are exposed through the insulating film 59. In the foregoing manner, a protective insulating film 25 is formed from the insulating film 59.

The foregoing steps are performed to manufacture the touch panel TP.

Advantages of First Embodiment

According to the first embodiment, the conductive connection part 33 has the serial connection structure in which the first connection layer 34A and the second connection layer 34B are connected to the lead line 30 in series. Moreover, the conductive connection part 33 is formed such that the first connection layer 34A is formed below the lead line 30 in the state in which the base end part 30s of the lead line 30 is connected so as to overlap with the first connection layer 34A, and that the second connection layer 34B connected to the first connection layer 34A is formed so as to cross over the ground line 32 with the interlayer insulating film 23 being interposed between the second connection layer 34B and the ground line 32. Thus, in the configuration in which the ground line 32 extending around the touch region T1 and each conductive connection part 33 are insulated from each other by the interlayer insulating film 23, it can be ensured that the conductive connection part 33 and the lead line 30 are connected together.

Since the base end part 30s of the lead line 30 is formed so as to have a width larger than that of the middle part of the lead line 30, the margin for displacement of the formation positions of the conductive connection part 33 and the lead line 30 is ensured. Thus, it can be further ensured that the conductive connection part 33 and the lead line 30 are connected together.

The first connection layer 34A is formed of the same film as that of the first and second electrodes 11, 17, and the second connection layer 34B is formed of the same film as that of the second connection part 19. Thus, the number of manufacturing steps is not necessarily increased in order to realize the connection structure of the conductive connection part 33 including the two connection layers 34A, 34B.

Thus, a good touch position detection function can be realized without increasing a manufacturing cost. As a result, the 2D/3D switchable liquid crystal display apparatus S which is capable of inputting accurate information in such a manner that a contact body such as a finger or a pen is used to perform various operations can be realized.

### Second Embodiment of the Invention

FIG. 15 is an enlarged plan view illustrating a connection structure of a conductive connection part 33 and a lead line 30 in a second embodiment. FIG. 16 is a cross-sectional view illustrating a cross-sectional structure along an XVI-XVI line illustrated in FIG. 15. FIG. 17 is a cross-sectional view illustrating a cross-sectional structure along an XVII-XVII line illustrated in FIG. 15.

The present embodiment is similar to the first embodiment, except that a configuration of a touch panel TP is partially different from that of the first embodiment. Thus, only part of the touch panel different from the first embodiment will be described. Note that the same reference numerals as those shown in FIGS. 1-14 are used to represent equivalent elements in later-described embodiments. Since those elements have been already described in detail in the first embodiment, the detailed description thereof will not be repeated.

In the first embodiment, the second connection layer 34B is connected to the first connection layer 34A so as to partially overlap with the protrusion of the first connection layer 34A protruding from the region overlapping with the base end part 30s of the lead line 30 toward the outer region. However, in the present embodiment, a second connection layer 34B is connected to a first connection layer 34A through a contact hole 23a formed in an interlayer insulating film 23.

Referring to FIG. 15, a base end part 30s of a lead line 30 of the present embodiment is formed such that a plurality of thin line parts 31c are combined into a frame-shaped part 31F surrounding a middle part of the first connection layer 34A. Referring to FIGS. 15-17, the contact hole 23a reaching the first connection layer 34A is formed in the interlayer insulating film 23 so as to be surrounded by the frame-shaped part 31F, and the entirety of the lead line 30 is covered by the interlayer insulating film 23. The second connection layer 34B is connected to the first connection layer 34A through the contact hole 23a. Moreover, the first connection layer 34A slightly protrudes, referring to FIG. 16, toward the outside of the interlayer insulating film 23, and the second connection layer 34B is also connected to the protrusion of the first connection layer 34A.

A touch panel TP having the foregoing configuration can be manufactured as follows: the contact hole 23a is formed in the interlayer insulating film 23 in the third patterning step of the first embodiment, and the second connection layer 34B is formed so as to be connected to the first connection layer 34A through the contact hole 23a in the fourth patterning step of the first embodiment.

Advantages of Second Embodiment

According to the second embodiment, the contact hole 23a is formed so as to be surrounded by the frame-shaped part 31F formed of the thin line parts 31c, and the entirety of the lead line 30 is covered by the interlayer insulating film 23. Thus, dissolving of the lead line 30 with a developer used for forming the interlayer insulating film 23 can be avoided. This reduces or prevents, as in the first embodiment, losing of part of the lead line 30 and therefore peeling of the lead line 30 due to the losing of part of the lead line 30. In such a good formation state of the lead line 30, it can be ensured that the conductive connection part 33 and the lead line 30 are connected together.

Since the second connection layer 34B is connected to the first connection layer 34A through the contact hole 23a formed in the interlayer insulating film 23, the first connection layer 34A does not necessarily protrude from the region overlapping with the base end part 30s of the lead line 30 toward the outer region so as to be connected to the second connection layer 34B. Thus, as compared to the touch panel TP of the first embodiment, a frame region of the touch panel TP can be reduced by such an amount that the area of the first connection layer 34A is reduced.

### Third Embodiment

FIG. 18 is an enlarged plan view illustrating a connection structure of a conductive connection part 33 and a lead line 30 in a third embodiment. FIG. 19 is a cross-sectional view illustrating a cross-sectional structure along an XIX-XIX line illustrated in FIG. 18. FIG. 20 is a cross-sectional view illustrating a cross-sectional structure along an XX-XX line illustrated in FIG. 18.

In the second embodiment, the configuration in which the contact hole 23a is formed such that a side end surface of the thin line part 31c is not within the contact hole 23a. However, in the present embodiment, a contact hole 23a is formed such that side end surfaces of thin line parts 31d are within the contact hole 23a.

Referring to FIG. 18, a base end part 30s of the lead line 30 of the present embodiment is formed such that the plurality of thin line parts 31d are combined into a grid pattern. In an interlayer insulating film 23, the contact hole 23a is formed such that part of the side end surfaces of the thin line parts 31d positioned in a center part of a first connection layer 34A is within the contact hole 23a. Referring to FIG. 20, part of an aluminum layer is dissolved and lost at the side end surface of the thin line part 31d positioned within the contact hole 23a, and therefore a lost part 100 is formed. Referring to FIGS. 19 and 20, a second connection layer 34B is connected to the first connection layer 34A through the contact hole 23a, and is directly connected to the thin line part 31d positioned within the contact hole 23a. Moreover, the first connection layer 34A slightly protrudes, referring to FIG. 19, toward the outside of the interlayer insulating film 23, and the second connection layer 34B is also connected to the protrusion of the first connection layer 34A.

A touch panel TP having the foregoing configuration can be manufactured as follows: the contact hole 23a is formed in the interlayer insulating film 23 in the third patterning step of the first embodiment, and the second connection layer 34B is formed so as to be connected to the first connection layer 34A and the thin line parts 31d through the contact hole 23a in the fourth patterning step of the first embodiment.

Advantages of Third Embodiment

According to the third embodiment, since the contact hole 23a is formed such that part of the side end surfaces of the thin line parts 31d are within the contact hole 23a, part of the aluminum layer of the thin line part 31d is, at the side end surface thereof, dissolved with a developer used for forming the interlayer insulating film 23 and is lost. However, part of the thin line parts 31d other than part where the contact hole 23a is formed is covered by the interlayer insulating film 23, and therefore it can be ensured that the thin line parts 31d covered by the interlayer insulating film 23 and the first connection layer 34A are connected together. Thus, even if the lost part 100 is, by the developer used for forming the interlayer insulating film 23, formed in part of the aluminum layer of the thin line part 31d positioned in the part where the contact hole 23a is formed, it can be ensured that the conductive connection part 33 and the lead line 30 are connected together through the first connection layer 34A.

Since the second connection layer 34B is, as in the second embodiment, connected to the first connection layer 34A through the contact hole 23a formed in the interlayer insulating film 23, the first connection layer 34A does not necessarily protrude from the region overlapping with the base end part 30s of the lead line 30 toward the outer region so as to be connected to the second connection layer 34B. Thus, as compared to the touch panel TP of the first embodiment, a frame region of the touch panel TP can be reduced by such an amount that the area of the first connection layer 34A is reduced.

### Other Embodiments

For the first to third embodiments, the following configurations and manufacturing methods may be employed.

<Arrangement of First Connection Layer 34A, External Connection Terminal 35, and Lead Line 30>

In the first to third embodiments, the first connection layer 34A and the external connection terminal 35 are provided below the lead line 30, but the present disclosure is not limited to such a configuration. The first connection layer 34A and the external connection terminal 35 may be provided above the lead line 30.

<Configuration of Liquid Crystal Display Apparatus S>

FIG. 21 is a cross-sectional view schematically illustrating a cross-sectional structure of a 2D/3D switchable liquid crystal display apparatus S of another embodiment. FIG. 22 is a cross-sectional view schematically illustrating a cross-sectional structure of a liquid crystal display apparatus S of still another embodiment.

In the first embodiment, the 2D/3D switchable liquid crystal display apparatus S in which the switching liquid crystal panel SP is arranged in the front of the liquid crystal display panel DP has been described, but the present disclosure is not limited to such a liquid crystal display apparatus. For example, a 2D/3D switchable liquid crystal display apparatus S in which a switching liquid crystal panel SP is, referring to FIG. 21, arranged in the back of a liquid crystal display panel DP may be employed. Alternatively, a liquid crystal display apparatus S which does not include a switching liquid crystal panel SP and which is configured to display only a normal 2D image may be employed. In either case, considering reduction in thickness of the entirety of the liquid crystal display apparatus S, it is preferable that a touch panel TP is formed directly on a surface of a substrate (e.g., a counter substrate 2) forming the liquid crystal display panel DP.

Alternatively, a liquid crystal display apparatus S may be configured as follows: a touch panel TP is not formed directly on a substrate forming a liquid crystal display panel DP or a switching liquid crystal panel SP, and is formed on a transparent substrate, such as a glass substrate, different from those forming the liquid crystal panels DP, SP; and such a transparent substrate is bonded to the liquid crystal display panel DP or the switching liquid crystal panel SP.

<Method for Manufacturing Liquid Crystal Display Apparatus S>

FIG. 23 is a flowchart illustrating the outline of a method for manufacturing a 2D/3D switchable liquid crystal display apparatus S of still another embodiment.

In the first embodiment, after the switching drive substrate 6 with the touch panel TP is manufactured, the switching drive substrate 6 and the separately-manufactured switching counter substrate 5 are bonded together. However, the present disclosure is not limited to such a method. A switching liquid crystal panel SP with a touch panel TP may be manufactured as follows: a switching drive substrate 6 is, referring to FIG. 23, manufactured in a switching drive substrate manufacturing step St21, and a switching counter substrate 5 is manufactured in a switching counter substrate manufacturing step St22; and after the substrates 5, 6 are bonded together in a bonding step St23 to form a switching liquid crystal panel SP, the touch panel TP is formed on a surface of the switching liquid crystal panel SP (i.e., a surface of the switching drive substrate 6) in a touch panel manufacturing step St24. Note that a backlight manufacturing step St25, a liquid crystal display panel manufacturing step St26, and a modularizing step St27 in FIG. 23 are similar respectively to the backlight unit manufacturing step St05, the liquid crystal display panel manufacturing step St06, and the modularizing step St07 in the first embodiment.

In the first embodiment, the switching liquid crystal panel SP is manufactured by the following so-called “drop filling.” In the bonding step St04, the sealing material 7 is applied in a frame shape on the switching counter substrate 5 or the switching drive substrate 6, and the liquid crystal material is dropped onto the region surrounded by the sealing material 7. Then, the switching counter substrate 5 and the switching drive substrate 6 are bonded together by the sealing material 7 and the liquid crystal material. However, a switching liquid crystal panel SP may be manufactured by the following so-called “vacuum injection.” A sealing material is applied in a substantially frame shape having a slit on a switching counter substrate 5 or a switching drive substrate 6, and the substrates 5, 6 are bonded together by the sealing material to form a bonded body having a gap cell. Subsequently, a liquid crystal material is, by using a pressure difference caused due to vacuuming, injected into the gap cell of the bonded body through an injection port formed by the slit of the sealing material, and then the injection port is sealed by a sealant. The same applies to the liquid crystal display panel DP.

In the first to third embodiments, the 2D/3D switchable liquid crystal display apparatus S has been described as an example, but the present disclosure is not limited to such a liquid crystal display apparatus. An image to be separated into images whose angles of view are different from each other in the second display state is not necessarily formed of images interrelated to each other, such as right-eye and left-eye images.

For example, the foregoing image may be used for a display apparatus configured to display, for a driver on a driver seat of an automobile, a video picture from a car navigation system and to display, for a fellow passenger on a front passenger seat, a video picture from TV broadcasting. In the case where different video pictures are displayed for a plurality of viewers, an arrangement pattern of the light shielding parts and the light transmissive parts of the parallax barrier, i.e., an arrangement pattern of the drive electrodes of the switching drive substrate 6, may be set as necessary so that an image displayed on the liquid crystal display panel DP and viewed through the parallax barrier can be separated into images which should be viewed by each of the viewers who are apart from each other with a predetermined distance.

The touch panel TP of the present disclosure is applicable not only to liquid crystal display apparatuses but also to various other display apparatuses such as organic electro luminescence (EL) display apparatuses, inorganic EL display apparatuses, plasma display apparatuses, field emission displays (FEDs), and surface-conduction electron-emitter displays (SEDs). The touch panel TP of the present disclosure is broadly applicable as long as a display apparatus includes the touch panel TP.

Although the preferred embodiments of the present disclosure have been described, the technical scope of the present disclosure is not limited to the scope of each of the foregoing embodiments. It will be appreciated by those skilled in the art that the foregoing embodiments have been described as examples, that combinations of components or processes and variations can be made, and that the variations fall within the scope of the present disclosure.

### INDUSTRIAL APPLICABILITY

As described above, the present disclosure is useful for the touch panel, the display apparatus including the touch panel, and the method for manufacturing the touch panel. In particular, the present disclosure is suitable for the touch panel for which it is required to ensure, in the structure in which the peripheral line extending around the touch region and the conductive connection parts are insulated from each other by the interlayer insulating film, connection between each conductive connection part and each lead line to realize a good touch position detection function. The present disclosure is also suitable for the display apparatus including the touch panel and the method for manufacturing the touch panel.

### DESCRIPTION OF REFERENCE CHARACTERS

S Liquid Crystal Display Apparatus

DP Liquid Crystal Display Panel

SP Switching Liquid Crystal Panel

TP Touch Panel

T1 Touch Region

T3 Terminal Region

11 First Electrode (First Conductive Pattern)

13 First Connection Part (First Conductive Pattern)

15 First Electrode Group (First Conductive Pattern)

17 Second Electrode (First Conductive Pattern)

19 Second Connection Part (Second Conductive Pattern)

21 Second Electrode Group (First Conductive Pattern)

23 Interlayer Insulating Film

23a Contact Hole

30 Lead Line

30s Base End Part

31a Thin Trunk Part (Thin Line Part)

31b Thin Branch Part (Thin Line Part)

31c, 31d Thin Line Part

32 Ground Line (Peripheral Line)

33 Inner Conductive Part

34A First Connection Layer

34B Second Connection Layer

41 Controller (External Circuit)

51, 57 Transparent Conductive Film

53 Multilayer Metal Film (Metal Film)

55, 59 Insulating Film

1. A touch panel, comprising:
a touch region which is a region where a touch position at which the touch panel had contact with a contact body is detected;
a terminal region which is a region formed outside the touch region and formed for connection with an external circuit;
a first conductive pattern formed for touch position detection and arranged in the touch region;
an interlayer insulating film formed so as to cover at least part of the first conductive pattern;
a second conductive pattern formed so as to cross the first conductive pattern with the interlayer insulating film being interposed between the first and second conductive patterns;
a lead line extending from the touch region toward the terminal region and covered by the interlayer insulating film;
a peripheral line extending around the touch region so as to pass between at least one of the first or second conductive pattern and a base end part of the lead line; and
a conductive connection part which is provided so as to cross over the peripheral line with the interlayer insulating film being interposed between the conductive connection part and the peripheral line, and which is connected to at least one of the first or second conductive pattern and the base end part of the lead line to electrically connect the at least one of the first or second conductive pattern in the touch region to the lead line,
wherein the conductive connection part includes
a first connection layer formed below the interlayer insulating film and connected so as to overlap with the base end part of the lead line, and
a second connection layer connected to the first connection layer with the second connection layer crossing over the peripheral line.

2. The touch panel of claim 1, wherein
the first connection layer is formed of a film identical to that of the first conductive pattern, and
the second connection layer is formed of a film identical to that of the second conductive pattern.

3. The touch panel of claim 1, wherein
the base end part of the lead line is formed so as to have a width larger than that of a middle part of the lead line between end parts thereof, and includes a plurality of thin line parts which are integrally formed such that a clearance is formed between adjacent ones of the thin line parts.

4. The touch panel of claim 1, wherein
the first connection layer protrudes from a region overlapping with the base end part of the lead line toward an outer region,
the second connection layer is connected to the first connection layer so as to partially overlap with a protrusion of the first connection layer, and
an entirety of the lead line is covered by the interlayer insulating film.

5. The touch panel of claim 3, wherein
in the interlayer insulating film, a contact hole reaching the first connection layer is formed corresponding to part of the clearance between adjacent ones of the thin line parts, and
the second connection layer is connected to the first connection layer through the contact hole.

6. The touch panel of claim 5, wherein
the thin line parts are combined into a frame-shaped part surrounding part of the first connection layer,
the contact hole is formed so as to be surrounded by the frame-shaped part, and
an entirety of the lead line is covered by the interlayer insulating film.

7. The touch panel of claim 5, wherein
the contact hole is formed such that part of side end surfaces of the thin line parts is within the contact hole, and
the second connection layer is connected to the first connection layer and the thin line parts through the contact hole.

8. The touch panel of claim 1, wherein
the first and second connection layers are made of a transparent conductive oxide, and
the lead line is formed such that a high-melting metal layer, an aluminum layer, and a high-melting metal layer are stacked on each other in this order.

9. The touch panel of claim 1, wherein
one of the first or second conductive pattern includes
a plurality of first electrode groups each including a plurality of first electrodes arranged in one direction and arranged parallel to each other,
a plurality of second electrode groups each including a plurality of second electrodes arranged in a direction crossing the first electrode groups and arranged parallel to each other, and
a first connection part connecting adjacent ones of the first electrodes in each of the first electrode groups, and
the other one of the first or second conductive pattern includes a second connection part connecting adjacent ones of the second electrodes in each of the second electrode groups.

10. A display apparatus, comprising:
the touch panel of claim 1.

11. The display apparatus of claim 10, further comprising:
a display panel configured to generate a display image corresponding to input image data;
parallax barrier means configured to allow viewing of the display image generated by the display panel at particular different angles of view between first and second display regions of the display image; and
a switching liquid crystal panel configured to switch between validation and invalidation of a function of the parallax barrier means to switch between first and second display states,
wherein the touch panel is formed directly on a surface of a substrate forming the switching liquid crystal panel.

12. A method for manufacturing the touch panel of claim 1, comprising:
a first patterning step of patterning, by using a first photo mask, a transparent conductive film made of a transparent conductive oxide and formed on a base substrate, thereby forming the first conductive pattern and the first connection layer;
a second patterning step of patterning, by using a second photo mask, a metal film formed so as to cover the first conductive pattern and the first connection layer, thereby forming the lead line such that the base end part is connected so as to overlap with the first connection layer;
a third patterning step of patterning, by using a third photo mask, an insulating film formed so as to cover the first conductive pattern, the first connection layer, and the lead line, thereby forming the interlayer insulating film such that at least part of the first conductive pattern and the first connection layer is exposed;
a fourth patterning step of patterning, by using a fourth photo mask, a transparent conductive film made of a transparent conductive oxide and formed on the interlayer insulating film, thereby forming the second conductive pattern and forming the second connection layer such that the second connection layer is connected to the first conductive pattern and the first connection layer; and
a fifth patterning step of patterning, by using a fifth photo mask, an insulating film formed so as to cover the second conductive pattern and the second connection layer, thereby forming a protective insulating film.
